(19) United States
(12) Patent Application Publication
(10) Pub. No.: US 2010/0208860 A1
(43) Pub. Date: Aug. 19, 2010

(54) GC QCMEHC nuclear power plants

(76) Inventor: Svetzar B. Petrovich, Chicago, IL (US)

Correspondence Address: Svetozar B. Petrovich, 6526 North Ponchartrain Blvd., Chicago, IL, 60646, US

(21) Appl. No.: 12/320,441

(22) Filed: Jan. 26, 2009

Related U.S. Application Data
(62) Division of application No. 11/809,132, filed on May 31, 2007, now abandoned.
Application No. 11/809,132 is a division of application No. 12/153,036, filed on May 13, 2008.
Application No. 12/153,036 is a division of application No. 11/807,748, filed on May 30, 2007, now abandoned.
Application No. 11/807,748 is a division of application No. 11/788,172, filed on Jun. 4, 2007, now abandoned.
Application No. 11/788,172 is a division of application No. 11/724,752, filed on Mar. 15, 2007, now abandoned.
Application No. 11/809,132 is a continuation of application No. 11/807,748, filed on May 30, 2007, now abandoned.
Application No. 11/807,748 is a continuation of application No. 11/504,304, filed on Aug. 14, 2006, now abandoned.
Application No. 11/504,304 is a continuation of application No. 11/385,078, filed on Mar. 20, 2006, now abandoned.
Application No. 11/385,078 is a continuation of application No. 11/724,752, filed on Mar. 15, 2007, now abandoned.
Application No. 11/724,752 is a continuation of application No. 11/418,157, filed on May 3, 2006, now abandoned.
Application No. 11/418,157 is a continuation of application No. 11/342,006, filed on Jan. 30, 2006, now abandoned.
Application No. 11/342,006 is a continuation of application No. 11/233,546, filed on Sep. 23, 2005, now abandoned.
Application No. 11/233,546 is a continuation of application No. 11/212,943, filed on Aug. 25, 2005, now abandoned.
Application No. 11/212,943 is a continuation of application No. 11/188,339, filed on Jul. 25, 2005, now abandoned.
Application No. 11/188,339 is a continuation of application No. 11/028,982, filed on Jan. 3, 2005, now abandoned.
Application No. 11/028,982 is a continuation of application No. 10/869,752, filed on Jun. 16, 2004, now abandoned.
Application No. 10/869,752 is a continuation of application No. 10/840,152, filed on May 5, 2004, now abandoned.
Application No. 10/840,152 is a continuation of application No. 10/742,485, filed on Dec. 19, 2003, now abandoned.
Application No. 10/742,485 is a continuation of application No. 10/190,993, filed on Jul. 8, 2002, now abandoned.
Application No. 10/190,993 is a continuation of application No. 10/156,192, filed on May 28, 2002, now abandoned.
Application No. 10/156,192 is a continuation of application No. 10/074,966, filed on Feb. 13, 2002, now abandoned.
Application No. 10/074,966 is a continuation of application No. 09/850,927, filed on May 8, 2001, now abandoned.
Application No. 09/850,927 is a continuation of application No. 09/518,884, filed on Mar. 6, 2000, now abandoned.
Application No. 09/518,884 is a continuation of application No. 09/376,957, filed on Aug. 18, 1999, now abandoned.
Application No. 10/869,752 is a continuation of application No. 10/840,152, filed on May 5, 2004, now abandoned.
Application No. 10/840,152 is a continuation of application No. 10/156,192, filed on May 28, 2002, now abandoned.
Application No. 10/156,192 is a continuation of application No. 10/074,966, filed on Feb. 13, 2002, now abandoned.
Application No. 10/074,966 is a continuation of application No. 09/850,927, filed on May 8, 2001, now abandoned.
Application No. 09/850,927 is a continuation of application No. 09/518,884, filed on Mar. 6, 2000, now abandoned.
Application No. 09/518,884 is a continuation of application No. 09/376,957, filed on Aug. 18, 1999, now abandoned.
Application No. 09/376,957 is a continuation of application No. 10/195,668, filed on Jul. 15, 2002, now abandoned.
Application No. 10/195,668 is a continuation of application No. 10/073,914, filed on Feb. 14, 2002, now abandoned.
Application No. 10/073,914 is a continuation of application No. 09/850,927, filed on May 8, 2001, now abandoned.
Application No. 09/850,927 is a continuation of application No. 09/518,884, filed on Mar. 6, 2000, now abandoned.
Application No. 09/518,884 is a continuation of application No. 09/376,957, filed on Aug. 18, 1999, now abandoned.
Application No. 10/742,485 is a continuation of application No. 10/156,192, filed on May 28, 2002, now abandoned.
Application No. 10/156,192 is a continuation of application No. 10/190,993, filed on Jul. 8, 2002, now abandoned.
Application No. 10/190,993 is a continuation of application No. 10/073,914, filed on Feb. 14, 2002, now abandoned.
Application No. 10/073,914 is a continuation of application No. 10/074,966, filed on Feb. 13, 2002, now abandoned.
Application No. 10/074,966 is a continuation of application No. 09/850,927, filed on May 8, 2001, now abandoned.
Application No. 09/850,927 is a continuation of application No. 09/518,884, filed on Mar. 6, 2000, now abandoned.
Application No. 09/518,884 is a continuation of application No. 09/376,957, filed on Aug. 18, 1999, now abandoned.
Application No. 09/376,957 is a continuation of application No. 09/518,884, filed on Mar. 6, 2000, now abandoned.
Application No. 09/518,884 is a continuation of application No. 09/376,957, filed on Aug. 18, 1999, now abandoned.
Application No. 09/376,957 is a continuation of application No. 08/950,898, filed on Oct. 15, 1997, now Pat. No. 5,941,273.
(60) Provisional application No. 60/231,514, filed on Sep. 9, 2000.
(60) Provisional application No. 60/226,750, filed on Aug. 21, 2000.
(60) Provisional application No. 60/220,358, filed on Jul. 24, 2000.
(60) Provisional application No. 60/217,308, filed on Jul. 11, 2000.
(60) Provisional application No. 60/123,504, filed on Mar. 9, 1999.
(60) Provisional application No. 60/123,207, filed on Mar. 8, 1999.
(60) Provisional application No. 60/123,153, filed on Mar. 6, 1999.
(60) Provisional application No. 60/123,504, filed on Mar. 9, 1999.

(51) Int. Cl. G21C 1/00

(52) U.S. Cl. 376/347

(57) ABSTRACT

Globose-conduit (GC) perimeter boundaries formations mass energy highest conserving (MEHC) Sets, balanced nuclear power plants, in millennium lifespan generate safest environmentally most friendly electric power; said perimeter boundaries' formations, multiple and serial enclosures, constitute a globose foundation globose reactor vessel, a containment building with a lower perimeter ancillary annex building for multiple primary coolant loops, light water reactors pressurized system, GC conduit tuned piping mass energy processes and buildings complex, boundaries safely closed perimeters. Two or four globose steam generators/separators two or four high pressure pumps' coolant loops and the reactor's support equipment floors in the annex building outside of the containment symmetrically align high pressure and temperature GC MEHC boundaries respectively two or four processes generated electrons turbine-generator buildings. The reactor, steam generators, processes piping and turbine-generators make GC mass energy formations.

This application is a continuation of the following applications serial numbers:
Ser. No. 11/809,132 May 31, 2007 and is a divisional continuation of
Ser. No. 12/153,036 May 13, 2008 and is a divisional continuation of
Ser. No. GC Laws application filed Jan. 26, 2009 (first filed) and is a divisional continuation of these:
Ser. No. 11/807,748 May 30, 2007 and is a continuation of
Ser. No. 11/788,172 Apr. 18, 2007 Confirmation No. 5382 assigned Jun. 4, 2007 date and is a continuation of
Ser. No. 11/724,752 claiming filing date Mar. 9, 2007, assigned Mar. 15, 2007 date and is a continuation of
Ser. No. 11/504,304 Aug. 14, 2006 and is a continuation of
Ser. No. 11/418,157 May 3, 2006 and is a continuation of
Ser. No. 11/385,078 Mar. 20, 2006 and said Ser. No. 11/418,157 is a continuation of
Ser. No. 11/233,546 Sep. 3, 2005 and is a continuation of
Ser. No. 10/869,752 Jun. 16, 2004 and is a continuation of
Ser. No. 10/156,192 May 28, 2002 and said Ser. No. 11/504,304 that is a continuation of said
Ser. No. 11/385,078 Mar. 20, 2006 and is a continuation of
Ser. No. 11/342,006 Jan. 30, 2006 and is a continuation of said
Ser. No. 11/233,546 Sep. 3, 2005 and is a continuation of
Ser. No. 11/212,943 Aug. 25, 2005 and is a continuation of
Ser. No. 10/840,152 May 5, 2004 that is a continuation of said
Ser. No. 10/156,192 May 28, 2002 and is a continuation of
Ser. No. 11/188,339 Jul. 25, 2005 and is a continuation of
Ser. No. 11/028,982 Jan. 3, 2005 and is a continuation of
Ser. No. 10/742,485 Dec. 19, 2003 and is a continuation of
Ser. No. 10/190,993 Jul. 8, 2002 and is a continuation of
Ser. No. 10/195,668 Jul. 15, 2002 that is a continuation of said
Ser. No. 10/190,993 Jul. 8, 2002 and is a continuation of said
Ser. No. 10/156,192 May 28, 2002 and is a continuation of
Ser. No. 10/073,914 Feb. 14, 2002 and is a continuation of
Ser. No. 09/850,927 May 8, 2001 and is a continuation of
Ser. No. 09/376,957 Aug. 18, 1999 and said
Ser. No. 11/223,546 Sep. 3, 2005 that is a continuation of said
Ser. No. 11/212,943 Aug. 25, 2005 and is a continuation of said
Ser. No. 11/188,339 Jul. 25, 2005 and is a continuation of said
Ser. No. 10/869,752 Jun. 16, 2004 and is a continuation of said
Ser. No. 10/840,152 May 5, 2004 that is a continuation of said
Ser. No. 10/156,192 May 28, 2002 which is a continuation of
Ser. No. 10/074,966 Feb. 13, 2002 and which is a continuation of said
Ser. No. 09/850,927 May 8, 2001 and said
Ser. No. 10/869,752 Jun. 16, 2004 and is a continuation of said
Ser. No. 10/742,485 Dec. 19, 2003 that is a continuation of said
Ser. No. 10/190,993 Jul. 8, 2002 that is a continuation of said
Ser. No. 09/850,927 May 8, 2001 and said Ser. No. 10/742,485 that is a continuation of said
Ser. No. 10/156,192 May 28, 2002 that is a continuation of said
Ser. No. 09/376,957 Aug. 18, 1999 and said
Ser. No. 09/850,927 May 8, 2001 claims benefit of
Ser. No. 60/231,514 Sep. 9, 2000 and claims benefit of
Ser. No. 60/226,750 Aug. 21, 2000 and claims benefit of
Ser. No. 60/220,358 Jul. 24, 2000 and claims benefit of
Ser. No. 60/217,308 Jul. 11, 2000 and is continuation of
Ser. No. 09/518,884 Mar. 6, 2000 and claims benefit of
Ser. No. 60/123,153 Mar. 6, 1999 and claims benefit of
Ser. No. 60/123,207 Mar. 8, 1999 and claims benefit of
Ser. No. 60/123,504 Mar. 9, 1999 and is a continuation of said
Ser. No. 09/376,957 Aug. 18, 1999 and claims benefit of
Ser. No. 60/123,153 Mar. 6, 1999 and claims benefit of
Ser. No. 60/123,207 Mar. 8, 1999 and claims benefit of
Ser. No. 60/123,504 Mar. 9, 1999 and is a continuation of
Ser. No. 08/950,898 Oct. 15, 1997, U.S. Pat. No. 5,941,273

### BACKGROUND OF THE INVENTIONS

Globose-conduit (GC) Sets Forms mass energy highest conserving (MEHC) the prior applications claim with crafts/trades, engineering disciplines, arts/sciences respective ordinary, finite, and infinitesimal constructions tolerances; also prior application, GC Boundaries, claims mass energy universal formations, ‘global warming’ issues and resolutions, herewith, continues for the national/global energy independence, for climate-control, resources/water conservation, energy-generation claims to world's only viable option.

A tyro to the prior applications should think of GC Sets as fluid mass energy processors with their electrons defined perimeter boundaries and forms functional parts as inventions analogous to atoms; as an electric current electron streams make perimeter conduit Inlet forms, enter an atom's perimeter boundary, interact with other electrons within the boundary, and equivalent streams of electrons mass leaves with an outlet conduit form. In said process an atom and its electrons define its GC Set and forms synchronous to the Conservation of Energy Laws it must follow in performing the electric field current required function.

Said stream, or a single electron, that passes through the atom mass energy field defines perimeter boundary, the atom's mass energy GC Set and forms respective domains function to conduct electricity in the cell's domain, herein referred to as substance or more simply the cell. As electrons infinitesimal mass is lost in the much more potent electrical charge, for cell's forms alone do not define substance properties. “Form equals function” may border on fatal oversight, in general. The GC Boundaries application shown ignored molecular, atomic infinitesimal interstitial spaces makes the Earth's atmospheric substances huge perimeter boundary difference substantiated through “global warming” geologic and astronomy findings. Determined functionality depending on forms only and disregard the Laws of Conservation of Energy for specific cells' perimeter boundaries and their ‘compactness’, determine functional values with forms only, leads to significant error margins. For said atom as a mass energy transistor/processor such determination entirely ignores the energy required to cause electron(s) streams to flow and rates of flow. In other words, ignores conductivity and the turn over-rates (the electrons passing rates through the atom's cell substance) thus ignores the properties which make few atoms extremely valuable mass energy transistors, processors.

Said GC Sets and forms quintessential mass energy highest conserving (QCMEHC) genome cells substances perimeter boundaries constitute fluids mass energy extremely valuable ‘transistors/processors’. Said engineering disciplines, application Forms Phenomena, Jul. 17, 2008 amended Jul. 19, 2008 Responses and Amendment One communications document the GC Set genome ‘form equals function’ methodology technique introduces two orders of magnitude error margin, for its fluids' self-conservation masses energy stays within the cell-fluids substance; the GC genome processes, perimeter boundaries, function as a most elementary cell, a drain trap, for least perimeter boundary frictional losses per each cell turnover, multiple times lower than current state of the art simple-trap. The GC Set cell turnovers, combustion engine piston revolutions per minute analogous, are multiple times faster than those in state of the art simple drain traps. Thus, for same fluid mass energy, the GC Set cell can either save on transport fluid, water, or pass heavier or greater weight of transported solid particles having much lower energy demand, required power, which makes for its enormous functionality. A lower friction, greater turnover rates expressed in percentages of the current art multiples show an unbelievable GC Set cell two orders of magnitude functional superiority.

The prior applications demonstrated that the GC Set genome rotates in two upright planes, orients in a horizontal plane, form cell substance perimeter boundaries which retain fluids mass energy maximum amounts, much as atoms do. Their frictional losses are much greater than those atoms shown measured in electrical conductors as resistance; nevertheless they are least for given fluids. Thus cell substance makes perimeter boundaries constituted highest mass energy at least fluid height and perimeter adjusted based on quanta mass amounts quantum mass paths-of-passage, QCMEHC defines. To extent boundary perimeters adjusts to gravitational field fluids mass energy synchronously retained level highest self-conservation are the Mass and Energy Conservation Laws mandated quantum masses synchronous infinitesimal responses.

GC Set cell vast superiority thus demonstrated also shows major differences between quanta mass quantum masses and electrons as the letter in gravitational field essentially contain no mass. Whereas, the electron charges generally respond in isotropic force field, fluids quantum masses respond to gravitational highly one directional force. Thus GC (globose-conduit) Set forms substance perimeter boundaries adjust to each horizontal plane orientation vertical plane rotations synchronous to the Mass Energy Conservation mandated Laws. Thus, most basic GC Sets and forms representatives shown in applications continuations starting with the first application is quite appropriate. Quite appropriate are GC Sets and forms groupings into angled and upright Domains Sets due to significant forms distinction synchronously mandated by the gravitational force one-directional magnitude in said horizontal plane orientation, upright planes rotations.

The GC Sets forms mass energy cell substances, Laws of Mass and Energy Conservation, enforce correctly “form equals function” rational, and proves, the “forms equal function” rational alone introduces potential enormous margins of error, in this instance in the order of two magnitudes. Thus, division of the inventions into arts and sciences, engineering disciplines, and crafts and trades application was absolutely appropriate. Said three professions' constructions are highly distinguishable in perfection and economics. Thus, ‘cell substances continuation’, Arts and Sciences state of the art engineering disciplines state of the transfers from theory to practice in each continuation application is most appropriate with each profession Sets and forms continued individually, with same drawings “form equals function” shown Sets and forms.

Thus, when there is a ‘function’ in space and the space retains sufficient mass energy which must synchronously implement the Laws of Conservation of Mass and Energy (‘cell substance’ to create ‘form’ perimeter boundaries) the Arts and Sciences, engineering disciplines said transfers to practice yield forms. Also, for present and known ‘cells substances’ and ‘forms’ known perimeters boundaries yield ‘function’.

Supra concurrences among ‘cells substances’, ‘forms’ perimeter boundaries, and ‘functions’ leave very little, or nothing, to rationalizing. The GC ‘cell substances’, perimeter boundaries, theory to practice wields extremely powerful inventions', principles' and methodologies' tools that resolve and solve issues. The application GC Boundaries resolves ‘global warming’, for atmosphere's fluid masses warm while the Earth's crust masses do cooling. GC ‘cell substances’ perimeter boundary mass energy self-preservations have almost human quality for organic and inorganic substances are entirely treated based strictly on their physical properties thus to mitigate chemical reactions constituted gradations and stratifications processes.

Finally, GC boundaries perimeter, cell structures, practice analogous to processors structured with transistors created multiple perimeters, boundaries higher advanced ‘cell substances’, which maintain said most basic forms, infinitely diverse in form likeness and perfections for GC Sets' populated GC Universe. Mass energy evolutions, GC Sets and forms, combat said stratification gradation processes and vice versa. The former intends to diversely saturate mass energy Universe and the latter wants it merged as one form; that leads into the following: Summary of the Inventions for GC QCMEHC NUCLEAR POWER PLANTS.

Pressurized and boiling water nuclear two different processes utilize a number of cooling systems to process water mass heat energy produced by fission processes in a reactor vessel core. A primary loop, liquid coolant water is circulated through the reactor in series with major equipment that convert heat into electrical energy, which in fact is energy transfer function while trying to mass quantities, water, constant.

In pressurized water reactors steam generators/separators inside the containment building are heat exchangers, either two or four in parallel, transfer heat energy from the primary loops radioactive coolant, pressurized to suppress boiling, into non-radioactive secondary loops equal number; high pressure pumps, in each loop, circulate coolant between the reactor and steam generators/separators; feedwater/condensate pumps provide steam generators/separators clean water for conversion into steam that drives turbines thus generators. The steam lines high up in the reactor building, along inside perimeter through a steam tunnel under the reactor and auxiliary buildings rise high up in the turbine building with elbows into the turbines.

Boiling water reactor (BWR), reactor vessel radioactive steam said elbows route into the turbines, also. This configuration eliminates steam generators/separators and their heat transfer inefficiencies. But, the secondary loop radioactive steam necessitates shielding with restricted maintenance during operations.

Both processes lack thermal expansions and perimeter boundaries integrity positive control which limit piping conduit, major equipment, and their supports, and thus buildings' structures plant longevities.

### SUMMARY OF THE INVENTIONS

Globose-conduit (GC) perimeter boundaries formations mass energy highest conserving (MEHC) Sets, balanced nuclear power plants, in millennium lifespan generate safest environmentally most friendly electric power; said perimeter boundaries' formations, multiple and serial enclosures, constitute a globose foundation globose reactor vessel, a containment building with a lower perimeter ancillary annex building for multiple primary coolant loops, light water reactors pressurized system, GC conduit tuned piping mass energy processes and buildings complex, boundaries safely closed perimeters. Two or four globose steam generators/separators two or four high pressure pumps' coolant loops and the reactor's support equipment floors in the annex building outside of the containment symmetrically align high pressure and temperature GC MEHC boundaries respectively two or four processes generated electrons turbine-generator buildings. The reactor, steam generators, processes piping and turbine-generators make GC mass energy formations.

The referenced GC Boundaries application splits mass energy processes into the globose-conduit and gradations stratifications Universe formations wherein the latter is preceded by erosion, deterioration, degradation, sublimation, evaporation, combustion, radiation, and irradiation, or decomposition processes encompassing the former, especially if the former is fluids mass, specifically water, with living organisms clearly in the globose-conduit Universe. The application resolves the ‘global warming’ phenomena issues globose-conduit and gradations stratifications processes perimeters boundaries cosmic and global combat. GC Sets forms, vessels, mass energy containments perimeters boundaries must reliably dominate during a lifespan. Structural engineering science methodologies determine internal stresses and deformations mass energy for external forces on structural members predicting lifespan limitations due to stated stratification gradations processes. Structural stresses, particularly bending stresses, limit structural members' lifespan.

In innovations to the current art, herein mass energy globose perimeter boundary GC forms' hoop stresses strategically substitute for conduit banding stresses, which avoids a piping spool's elbow or bend. Furthermore, piping loops expansion joints provide required system integrity preferred axial loads utmost reduced stresses, entirely avoids banding stresses, and thus, significantly prolongs power plants' life span. The reduced, avoided stresses conserved mass energy thus systems retained away from said stratifications gradations processes not only prolongs plants life span but is entirely utilized, thus boosting plants' power generation capacities; the conserved mass energy is primarily retained in the primary coolant recirculating loops resulting in mass energy loops higher circulating rates, nuclear fuel cells rods increased cooling that allows for higher energy fuel rods. Further, expansion joints relieve thermal axial stresses causing flexing elbow or shell perimeters, longevity preferred bending stresses less than 15% of building codes allowable.

Accordingly, GC fluids mass energy piping loops two, four (or multiple) diametrical branches are symmetrical about the reactor vessel, each recirculating reactor cooling water aligns containment building penetrations, the annex building reactor vessel steam generators/separators thus forcing thermal expansion joints. Each steam generator/separator has its high pressure pump which returns recirculating water to the reactor vessel. Said loops outgoing legs straight piping spools align equipment symmetrical configuration radially extending from the cylindrical reactor vessel and reactor building into said circumferential annex. Symmetrical, radial, diametric coolant loops, mass energy, heat the GC Sets process into electrical power.

Reactor building piping penetrations, structural restraints constitute one of these expansion joints:
Inorganic fullerene coated surfaces thermal expansion/contraction prestressed expansion joints,
Multiple perimeter enclosure inorganic fullerenes coated surfaces, prestressed expansion joints,
Structural mechanical electro-magnetic damped vibration frequency confined expansion joints,
Structural, dynamic electro-magnetic field damped vibrations naturally sealed expansion joints,
High hydraulic pressures structural, prestressed, electromagnetic, energy-pipe expansion joints.

The reactor building wall penetration constitutes a stainless steel sleeve through the wall; a flange and a counter-flange on the wall respective inside, outside faces bolt together by two rows of bolts equally spaced and closely spaced two concentric bolt circles; boltholes lowest drilling-tolerance clearances allow bolts through piping loops' legs flange, counter-flange, with adequate separation from the reactor building penetration steel liner, allows for high energy pipe thermal movement. Here, the loop piping outgoing leg horizontal centerline thermal expansion remains vertical, no horizontal components at said penetration, as the piping expands radially from the reactor vessel. The flange, counter-flange machined MoS₂ inorganic fullerenes, IF, large diameters, coated back face bears against an annular-disk respective IF coated surface having concentric grooves, clear of bolt-holes for pressure packed lubricating, turbine paste under torqued bolts pressure, each grove a permanently packed seal in the lubricated IF surfaces interface that allows for said thermal movements. Each annular-disk bears against structural insulation, to in turn, bear against the reactor building steel liner respective face; a structural insulation spool, with drilled bolt-holes lengthwise through said spool heavy wall machined thickness, fits snuggly between the flange and the counter-flange through (with required clearances) said steel liner, liner insulations and annular-disks. Said bolts, through the flange, the insulation spool, and the counter-flange, assemble with washers at each end bearing against the respective flange, counter-flange, a nut, and a lock-nut torque tensioned. The containment flanges, the disk-plates, and the steel liner structural insulation fully bear with more than sufficient surface area thus is affixed to the reactor building steel liner. A backing-ring welded to the steel liner around flange, counter-flange has its outstanding edge radially turned inward into a lip to retain the liner insulation with adequate thermal separation from the annular-disks; and each likewise makes a penetration structural stiffener. The liner insulation entire thickness surface area bears against its respective backing-ring width precluding the insulation, the annular-disks slip; the insulation, annular-disk tongue and groove matched bearing surfaces affix interfaces; ring inner-face/turned-lip stiffeners/insulation bearing precludes insulation rotations, also.

Said structural insulation spool snuggly fits the stainless steel sleeve outside diameter, in-between the annular-disks, at optimal thermal expansion. The annular-disk boltholes slight vertical-slots allow for loop's leg centerline, the reactor vessel synchronous vertical thermal movement; the flange bolt-holes can have small caulking countersink under oversized washers, with Thermeez 7030 or similar fireproof sealer.

The stainless steel sleeve inside diameter machined surface 5-10 nanometers thick IF coated, with the welded flange is preheated and slid-over machined respective loop IF coated straight spool. The spool and sleeve and said flange/counter-flange, annular-disks inorganic fullerenes surfaces seal the penetration.

The joint second-invention has the annular-disks boltholes oversized, housed, instead of slotted to allow the return legs' respective movements. Instead of boltholes allowed, said biaxial thermal expansion movements two or several stacked annular-disks, as subsequently described base plate invention provides.

Bolt and stud connection assemblies must include washers under the member that is torqued. The safety related bolt and stud, housed slotted or oversized holes assemblies, require their respective tensions statistically sampled during each refueling outage verifying 100% compliance. ZIRCAR Calcium silicate characteristics, insulation workability, fabrication, and properties exemplify structural insulation required. Radial thermal expansion coefficients differences for stainless steel, structural insulation and steel require aforesaid space-gap sealers. The flanges, structural insulation, and counter-flanges bolted connections do not limit pipe penetration longitudinal thermal movement occurring between the pipe spool and its sleeve.

The aforesaid inorganic disulfide fullerenes MoS₂ (or WS₂) coated surfaces and housed boltholes, prestressed thermal expansion/contraction joints, supra two major innovations to the current art permit the energy-pipe mechanical electro-magnetic flux confining-dampened structural expansion joints as the third major innovation. Annular ironclad electromagnet coil housing welds to said containment liner back face, which also includes radially welded penetration stiffeners around each of piping penetrations; half-sleeves matched pair of sufficient length bolt together around the pipe and its structural insulation; the half-sleeve equally spaced arms around circumference radially extended from their sleeve welds to respective annular soft iron disk plate backside, having a face to face head contact with the electromagnet's head flat surface; in difference to electromagnet clutches/breaks known art, said magnet's head surface restrains any motion when current passes through the coil magnetizing the head with mass of steel liner an enormous heat sink.

The third major invention ironclad annular enclosure constituted of magnet multiple disks welded side by side into the annular iron enclosure allow electromagnet disks' common or individual utilizations.

Combining supra three into the fourth major innovation has said reactor building liner penetration circular opening reinforced at each containment penetration, with a short sleeve through the liner, groove-welded both sides, containment's face flush; said annular ironclad coil electromagnet enclosure face flush with said liner face is radial longitudinal stiffener sides full length both faces groove-welds attached to the sleeve; a backup-flange annular-disk T-flange shape, with one flange rim groove welded to said steel liner has the other flange rim as the insulated supra backstop and said flange. Said structural insulation entirely encloses said electromagnet(s). Electrical fireproof conduits preclude fire damage to said electromagnet's power lines; again, an electromagnet ring make-up of the abutting adjacent electromagnet disks welded in an annular-disk ironclad electromagnet enclosure substitutes for said annular-disk electromagnet, with the annular enclosure electromagnet-disks, operating as the individual, joint, or any one of disk combinations. An iron, annular-disk as the flange or as welded face of said stainless steel flange facing its electromagnet insulation thicknesses separated, the ubiquitous, preferred electromagnets heads annular-disks natural and electromagnetic field/fluid dynamics dampen vibrations' responses of said sealed, tuned, expansion joints.

Electromagnetic fluids change their viscosity in proportion to the applied magnetic strength; thus, the viscosity is controlled dynamically, which allows for active damping. Electrical energy small amount controls mechanical energy large amounts, for highly controlled very efficient vibrations' control method; magnetic fluids viscosity, stiffness, adjust in milliseconds over frequencies and temperatures wide ranges.

The turbine lubricating paste utilized as oil base in an electromagnetic fluid having extremely fine soft iron grains, instead of aforesaid pure paste, is an innovation that continues the forth major innovation.

The flange, the annular-disk aforesaid concentric grooves a vertical groove connected, substantial distance from anyone bolthole connected through the annular-disk angled mainly vertical hole, a fireproof conduit, through supra described insulation, backup ring to an electromagnetic fluid container implements an electromagnetic fluid innovation; the container, attached to containment building liner, in the magnetic field when the energized magnet does not permit flow or when the paste is insufficiently heated to change into a fluid state, controls said fluid flow during plant operations or intentional electromagnets shutdowns.

Aforesaid two implemented innovations combined into the third have the soft iron annular-disk at least in a part as the electromagnetic fluid container that connects to the flange, annular-disk vertical hole.

A preferred, near future most advanced expansion-joint embodiment as the fifth major innovation has the annular ironclad electromagnet's heavy housing groove welded to the containment steel liner both sides making the housing an extension of the liner. Said stainless pipe spool steel sleeve with IF interface has insulation retainer-disk short height (relative to the insulation thickness) stainless steel flanges welded to the sleeve, at sufficient distance away from its near flange or counter-flange; retainer-disks retain supra structural insulation machined spool, with its inside diameter with precisely same diameter as the sleeve's outside diameter at operating range highest temperature. A machined, soft iron (stainless-steel as option) thin-wall (fraction of the insulation thickness) tube is imbedded concentric in aforesaid retained, structural insulation spool with a separation at each end from the retainer-disks; wound wire coil upright axis makes a line of symmetry for the entire assembly. A flange, counter-flange inside diameter very close machined tolerance assures the flange and the electromagnet's housing unimpeded full face to face continual contact that avoids electromagnetic paste leaking. Under electromagnets effects said iron pieces obtained degrees of permanent magnetism preclude electromagnetic fluid leak. In containment pressure buildup, the flange presses against the electromagnet housing and iron pieces through time reverting to a natural magnet state positively seal the containment penetration and positively absolutely when the electromagnet is energized. The electromagnet's ironclad housing constituted flat disk faces are machined and covered with deposited five to ten nanometers thick flange, counter-flange extremely flat layer in contact with similar layer of IF, MoS₂, WS₂ or similar iron based inorganic fullerenes' coats; said housing entire surfaces and said flanges electromagnet's permanently magnetized assembly natural, permanently and strongly maintain enclosure, especially with the electromagnet energized; electrical power preferably provided through a metal conduit connects to the electromagnet's housing on the annex building side. Provisions for the fluid supply, drain are through counter-flange respective highest, lowest elevation to fluid enclosure access, inside the annex. The electromagnetic fluid enclosure consists of flanges on sides, electromagnet housing, and the thin wall iron tube, structural insulation composite. In operation, the pipe/sleeve presses against insulation spool to press against ‘cold’ thin-wall tube, ‘cold’ flange, counter-flange, to ‘cold’ electromagnet enclosure, to the ‘cold’ steel liner; ‘cold’ meaning materials heat transfers with the pipe/sleeve hottest and the liner coldest.

Again, instead of one electromagnetic coil, said housing may enclose numerous separate ironclad magnetic-disk enclosures making similar aforesaid enclosure form, with individual power supply for each coil disk with direct, IF surfaces, contact with the flange and counter-flange. Coil disks-power operations should symmetrically energize the disks about the enclosure generally, thus in pairs or preferred groups of three, when a failure in one disk is overcome by the other operating disks or one group's failure overcome by the other operating groups. Sequential or back-and-forth disk operations under pipe vibrations induced shear stress failures in the fluid magnetized mass structural member said operations reduced shear stresses dissipates vibrations energy; magnetized fluid when energized heals shear failures, which tunes vibrations response, magnetized fluid latent muted dynamic responses out of vibration frequencies resonance ranges.

The electromagnetic soft iron core, continuous single wound wire, coil disks axis parallel with the pipe spool centerline inside their ironclad annular enclosure for a separation from the enclosure allows for each individual disks' removal, repair and replacement inside said annex building without cutting the pipe spool. Remote-control sensors as extensometers, with at least two-digital-channels, transmitted vibration displacements to data processing units allow for computed electromagnet(s) operation; the insulation/thin-wall tube spacings from the electromagnet(s) housing constitute said spool's largest lateral displacements.

The supra five major innovations, especially the fifth, make first step toward the first, second, and third most significant innovations; the first step constitutes supra four of the listed five expansion joints as the five nuclear power plants thermal expansions, vibrations, elbows, bends or kinks and fluids directional changes major innovations. The first most significant innovation allows for nuclear plant electrical power generation to highest efficiencies with much longer life spans, thus much lower power generation cost per kilowatt-hour, through subdivided present art containment building into three space entities with specifics in function. The first significant innovation constitutes the containment building reactor vessel cylindrical space with the diameter that allows maintenance, such as in refueling the vessel head removal, reinstalling of the reactor head; thus essentially unchanged space utilization, from the present art, enormously reduces the containment building diameter from about 140 feet to a diameter barely greater than the reactor vessel shield wall, from the containment foundation to elevations that must surpass the steam generator/separator highest point, with corresponding construction capital investments' savings. Very much freed plant space results from its removal from the containment building with construction pressure vessel's structural parts whose stress analysis, thus follows:

□₁/r₁+□₂/r₂=p/t,

wherein r₁is radius in this case that of cylinder height that is very large to infinite which removes the first term of the equation. The □₂ is hoop stress essentially entirely reduced by said annex building shear-walls extending radially in respect to the reactor vessel, from said cylindrical containment building part through the annex building, in turn transferring the hoop stress □₂ through said shear walls constituted primarily of various structural steel bracing, from said circumference into the reactor foundation. Then, the cylindrical wall is designed for bending moments in spans between the shear-walls/structural bracing; then, pressures ‘p’ relate to thicknesses ‘t’ shear and bending stresses and not on the above equation applying specifically to pressure vessel membranes. Subdividing the annex building into reasonable width bays, with aforesaid structural steel said bracing, radially converge into narrow bays, subdividing the cylindrical wall into very short circumferential spans very much smaller thicknesses, more economical sections than the present art. Said containment building second of three parts, the upper half-dome part, is unchanged, from the present art, according to the above equation's terms, with its base constituting a floor slab supported by the annex building perimeter wall under the dome's shell and said bays' structural steel bracing or shear walls. Said containment building subdivided from one into three ‘globose’ forms is obviously a preferred economical containment construction and is much more secure; a flying turbine disk or a flying missile must penetrate the dome, its floor slab, and said cylindrical wall thick sections. The turbine rotational plane disk released into near ground projectiles will have trajectories away from the containment building. A tornado created missile lower energy ground elevations paths have to pierce through the annex building bays, walls, floors and equipment, such as steam generators/separators, high pressure pumps, and at least the cylindrical wall in order to reach the reactor vessel's shield wall or its head. Said dome, its polar crane precludes a missile almost entirely vertical reactor hitting trajectory; the subdivided containment building constitutes multiple sequential perimeter boundaries much safer design with globose forms composites protecting, the globose reactor centric location, for surviving a serious annex building damage with one cooling loop functioning; the containment liner penetrations reinforcement is analogous to naval vessel pneumatic door-sill designs. Globose perimeter surface contains most space that mass energy prefers, least lengths, linear, radial, most interstitial spaces volume, and most natural paths, mass energy patterns that light and radiation exemplify. The annex has exactly said paths, spaces, over ten floors, the present art sorely missed maintenance space. The globose forms reduce and avoid bending stresses tension-compression and provide for said longevity.

The second most significant innovation locates steam generators/separators in the annex building, just outside the containment cylindrical wall, under the containment's dome, to enable their replacements. Said floor slab includes access hatches, just above the steam generators/separators, in design analogous to the containment main access equipment hatch, said naval vessel door/sill designs. Highest lifting capacity crane motor, block and tackle and outriggers in the containment through the equipment main access hatch the containment building polar crane places above a steam generator separator in preselected containment, and annex building's designed locations, for replacements purposes egress and ingress spaces, preselected length, width and elevations through the annex building with bays structural members temporary removed for adequate spaces and supports and cranes capacities. This includes annex building perimeter oversized doors and or removable structural frames and panels. The steam generator/separator is lifted for a flat bed trailer wheel to wheel, axle to axle closes spacing one section at a time assembly thus reassembled having steam generator/separator multiple cranes lowered onto the flat bed trailer cradles. Adequate capacities of flat bed trailers and cranes replaced steam generator/separator constitutes said plant longevity second step, as the present art imprisons the steam generators/separators for the containment buildings' least longevity.

The third most significant innovation ameliorates the present art structures mass energy losses for the globose reactor, ‘globose’ steam generator/separator vessels significantly highest heat energy transfer, with supra containment/annex building configuration. Clearly, high energy piping, conduits, least masses occur in straight, short (least length), least vibrations piping (least energy loss to structure) passes through sealed globose perimeter boundary (containment building) heat energy (fluid mass pressure, temperature) transfer among said globose vessels for fluid mass least directional change; said GC perimeter boundaries longevity mandates almost nearly free thermal expansions, dampened dynamic vibration responses for the mass energy preferred said paths and patterns perimeter boundaries' formations multiple serial enclosures light water reactors (herein) pressurized system conduit tuned piping mass energy processes and buildings complex, boundaries safely closed perimeters. Said plant's mass energy least, shortest radial piping paths inherent peculiarities arising from the present art piping conduits flexing allowed thermal expansions built into major equipment mass energy conduits Inlet and outlet forms. Said peculiarities not withstanding the steam generators/separators, the loop return legs high pressure pumps are the annex building located, very close to the containment liner and concrete wall on one side, with the reactor vessel on the other side; pipe spools shortest lengths, least vibrations, tuned containment penetrations and steam generators base-plates. Steam generator/separator two return legs per loop constitute preferred symmetric configurations version.

Current state of art, nuclear power plants major equipment is engineered, to an extent of ‘globose’ shape; however, major equipment and building configurations, incorporated as a whole, exemplifies crafts and trades construction. The Background depicted “forms equal function” methodology rationale without examined ‘cell substance’ specifics and scrutinized ‘cell’ with closest observation of perimeter boundaries leads to error margins on the order of two magnitudes, especially in fluids related mass energy; the ‘forms equal function’ rationale has uncertainties even when examining a crystalline structure from solidification of a chemical element, a compound, or a mixture that makes regularly repeated internal arrangement of its atoms and often external plane faces. On the other hand, regularly repeated paths with patterns make said GC Sets and forms repeated quantum mass energy internal arrangements with perimeter boundaries not as distinct, because externally GC Sets and forms do not readily disclose fluid masses' laminar flows; ‘forms equal function’ rationale entirely fails without the Laws that distinguish fluids laminar flows most orderly ‘substance’, quantum masses energy arrangements, least resistance paths, paths-of-passage of least energy demand, PPLD, that has the ‘function’, energy/power self-conservations. Fluid mass energy ‘forms equal function’ alone always errs, proven unable to differentiate mass energy functions two orders of magnitude among crafts and trades, engineering disciplines, and Arts and Sciences Sets and forms, and not much less error margin distinctions with a combined ‘function’ of said three. Thus, said current art of nuclear power plants, including patents allowances which do not discern ordinary from perfection, analogous to crystals, crystalline lattice from diamonds' light dispersions, and from bizarre applications and patents to diamonds perfection said ‘genomes’ QCMEHC. Unique quantum mass constitutes ‘substance cells’ given locations precisely performed ‘function’: for diamonds light dispersions, for ‘genomes’ Earth's most unique, rarest, clearest ‘function’ more than diamonds rare mass energy patterns boundary MEHC transistors/processors. The ‘genomes’ make the Universe only such embodiments with ‘black holes’ as only possible exceptions.

Mass energy paths and patterns internal, external arrangements with perfection and imperfections grow GC Sets and forms analogous, much like crystals do, with the whole structure conglomerate of alike elementary ‘cell’ units. Said MEHC perimeters boundaries can overcome to an extent apparent crafts and trades construction deficiencies, ‘cell’ imperfections through applications claims GC Sets and forms mass energy paths shown patterns, inventions, principles and methodologies. Electromagnetic fields and fluids utilizations as part of flexing perimeter boundaries continues from the applications Ser. No. 09/850,927, dated May 8, 2001; Ser. No. 09/518,884 dated Jan. 16, 2001; and Ser. No. 60/187,270 dated Jul. 11, 2000. Supra electromagnetic seals complement said containment, annex building and the reactor vessel, steam generators appropriately configure perimeters, boundaries' formations, multiple and serial enclosures from said crafts and trades to engineering methodologies GC Sets and forms; pruned, compartmentalized reactor, containment, building content except for the reactor vessel only, has huge cost savings, initiates balanced, radial and tuned plant, for said annex added over ten equipment floors. Supra ‘substance’ part, aside from ‘forms equal function’ has fluid mass energy perimeters boundaries freed thermal expansions avoids thermally induced static and dynamic bending moment stresses, except for the reactor, steam generator/separator inherent peculiarities.

High energy MEHC conduits least (fluid) mass, straight, short, least vibrations piping has primary cooling loops faster turnover rates, heat energy delivered to steam generators/separators with least friction losses, lower high pressure pump power required. Thus, saved power allows for enlarged piping diameter further reduced frictional losses with larger fluid mass per turnover, entirely combustion engine analogous to much lower frictional loss higher revolutions per minute larger cylinder displacement produced energy. Said prior application ‘genome’, two orders of magnitude mass energy savings, makes a very useful point.

Steam generators/separators are weakest links in the primary cooling loops; thus four innovations. One, allowed thermal expansion, damped/dampened pipe vibrations ameliorates the steam generator tubes stress corrosion cracking related to vibrations. Two, the annex building's greater interstitial, maintenance space allows quicker, easier access to locations. Three, the steam generators/separators said replacements remove them from plants' longevity critical lists. Four, in said annex, their horizontal designs is practical.

Said compartmentalized reactor building, the annex as its extension, freed thermal GC expansions avoided conduit bends, significantly reduces the present state of art structural perimeters banding moment stresses, and moves nuclear power plants construction from crafts and trades to MEHC patterns. Banding stresses removals from structural perimeter boundaries makes GC structures compatible with fluids which transmit shear stresses, only. Avoided banding stresses indicate no mass energy directional change which enhances MEHC. Thus, the current art in numerous instances and MEHC are entirely incompatible. Said horizontal steam generator/separator peculiar GC form entirely reflects its reactor building confined space and related thermal expansion provisions. Supra inventions provide for MEHC approaching a QCMEHC power plant embodiment eliminated all high energy piping elbows, especially with inclusion of the last of the listed five expansion joints. Steam generators/separators in said containment extension annex permits preferred horizontal versions or their shape peculiarities along with the reactor vessel interactions, elbows shape and piping configurations deviations from globose forms strengthened with various stiffener plates.

Then the sixth major innovation eliminates the steam and primary cooling loops' isolation valves, with the seventh eliminating substantial structural supports and restraints because of significant reductions in piping stresses in general or bending stresses in particular; again, due to GC perimeter boundaries freed thermal expansion configurations and said ameliorated inherent peculiarities. Said reduction of stresses is proximate to one order of magnitude. Mass energy paths and patterns are short, compact, and streamlined as GC perimeter boundaries are allowed to expand and contract once per refueling outage, currently about 18 months; and low stress members metal fatigue, in less than one thousand cycles, is not a valid concern. Currently postulated double guillotine pipe break scenarios no longer constitute valid concerns, especially for primary cooling loops and especially with supra innovations lead to longevity innovations that follow. Primary cooling loops' major equipment, the steam generators/separators, respective high pressure pumps and the reactor vessel GC perimeters' boundaries freed thermal expansion, with their respective structural supports, constitutes the sixth and the seventh major innovation significant part; steam generator/separator one or multiple legs base plates weld to a larger base plate, counter-plate assembly, with the counter-plate stainless steel base same or precise finite difference higher elevation in respect to the reactor vessel's steel supports base plates; each high pressure pump has the same, but much smaller, assembly, with the cooling loops piping centerlines remaining horizontal which said precise finite difference(s) provides. Each of the assembly base counter-plates surface area is supported by said insulation, and is inside side insulation ring that elongates into an ellipse with the major, minor axis difference and axis orientation that have precisely the thermal expansion magnitudes and directions allowed. With the steam generators/separators, said axis difference orientation is radially outward from the reactor vessel upright centerline; under heavy pressures said axis make-up perimeter ellipse, enclosing vectors that vectorially sum each assembly radial and polar thermal expansions in respect to said reactor vessel centerline. The counter-plates surface area/perimeters each shape is smaller than said insulation ring which is backed by a stainless steel plate ring. Said smaller counter plates permit thermal expansions, contractions, primarily along the respective base plate's surface area interface, with insignificant base plate/counter plate bearing reduction area surfaces. Said base plates further include a rim-plate upwardly extended along each plate's perimeter to face said thermal expansion elongation gap to said insulation backed by the steel ring as said assembly backstop. The rim-plate height matched by the insulation and the backstop width is at least several inches for all locations, with thickness of each that provides for sufficient structural strength. At least four machined channel-guides oriented for the respective base plates thermal expansions/contraction axial direction, channel location and orientation. Said channel guides counterparts machined pins among various pin shapes may constitute a threaded stud, each through a pin arm threaded-hole with its rounded point torqued pressed into said channel counterpart groove; welded to the backstop the aligned pin arm allows base plate said axial thermal expansion moves.

The base plate, counter-plate said IF coated surfaces readily allow thermal expansion movements. Unless regulations required, the steam generator/separator huge weight makes channels/pins unnecessary.

The base plate covered by the turbine paste lubricants, with/without a heavier wax sealed surface, allow melted paste to flow, into and out of thermal expansion space through several holes through each of the rim-plates, lubricating the IF interface. The base-plates as with the containment building penetrations, the turbine pastes as IF base fluids allow electromagnetic disks said numerous arrangements with housing welded to said base plate or backstop, positively attached with full penetration welds of sufficient lengths.

Said high hydraulic pressures structural, prestressed, electromagnetic, energy-pipe, the listed fifth among expansion joints constitute the forth most significant innovation. A high pressure steam line spool one end has about three wall thicknesses, greater outside diameter than expansion joints counterpart-spool outside diameter that is turbine direction oriented with typical spool wall thicknesses and outside diameter for the other end. Said spool larger diameter, heavier wall, thicknesses end is machined to inside diameter slightly smaller than outside diameter of the counterpart-spool plus a welded reinforcing-sleeve thickness, matched, precisely machined diameters; the inside diameter accounts for required inorganic fullerenes, IF, coated entire surface. Said inside diameter transition that matches the machined counter-spool's end has a smooth sharp angle beveled surface which butting into the welded reinforcing-sleeve closes the expansion joint outer portion with the sleeve's front surface, transition bevels matching surfaces; the expansion joint transition from the machined inside diameter to piping spools' inside diameter constitutes another slightly sharper angled bevel that matches exactly the counter-spool's machined end bevel, wherein said matching bevels abutted closes the expansion joint inner portion; said expansion joint's inner, outer portions closing simultaneously closes the expansion joint. Said bevel that terminates into the pipe spools' inside diameter has a very fine, small, outside corner fillet which finitely, smoothly extends into the bevel for a fraction of wall thickness and a longer length along inside diameter surface with said fillet lengths creating suction in the expansion joint as it closes; about one magnitude less than the building codes allowed piping stresses, herein, inventions implemented close and open the expansion joint for anticipated millennium longevities.

Each expansion-joint spool welds to another expansion spool from the counter-spool's end facing the containment with at least one preferably two welded two reinforcing-sleeves, which are prestressed by a preheated outer-spool slid over and allowed to cool over the reinforcing-sleeves. The reinforcing-sleeve outer, the outer-spool inner diameter surfaces are machined for a precise ‘negative’ tolerance wherein said surfaces have each inorganic fullerenes coating with the ‘negative’ tolerance caused prestress. The outer-spool, the expansion-joint spools have same lengths; the reinforcing-sleeves are spaced for the expansion-joint spools made first welds, with needed access; then, the outer-sleeve is force slid into a position for its weld. At least two preferably three outer-sleeves complete the expansion joint and the reinforcing-sleeves with pre-welded locations from each expansion-joint sleeve respective end having equal spacing. At least the outer-spool closest to the containment and preferably three reinforcing spacings enclosed volume shall have fluid inflow and outflow (drain) pressure portals positive shut-offs; a fluid, such as turbine lubricants molten paste, volume under pressure in said spaces monitored continually assures the expansion-joint seal integrity. Supra electromagnets and turbine pastes electromagnetic fluid assemblies allow electric current and fluid pressure monitored seal integrity; supra and following depict magnetic coil location orientations.

Said high energy line expansion joint eliminates the present art steam lines paths snaked along the containment building's perimeter from the top of each steam generator/separator, along containment sides through the containment floor-slab, into a steam lines tunnel under the containment and auxiliary building to rise to an elevation above the turbine and make elbows into the turbine casing. Said inventions take out all of the present art complexities huge capital expenditures. Said major equipment peculiarities are taken for consideration. Most significantly, eliminated steam tunnel structure and piping in the containment and steam tunnel eliminates substantial structural supports and restraints that undermine plant's longevities by thermal expansions and pipe vibrations, such as water and/or air ‘hammers’, energy transfers from already generated energy into piping and buildings structures; such losses take directly ‘cream’ benefits out of the generated energy and sink it into structures' degradation, making their lifespan shorter than a millennium;

The fifth, most significant innovation, modifies the present art said reactor, annex, auxiliary, with spent fuel pool, decontamination and turbine equipment, buildings functions, and interstitial, maintenance spaces from crafts and trades to engineering disciplines designed construction, electromagnetic fields said fluids seal, globose-conduit, GC, balanced and tuned perimeter boundaries to allow millennium longevity. Described conduit direct shortest conduit paths and globose major equipment and buildings globose forms perimeter boundaries simulate QCMEHC self preservation, self conservation preferred paths and patterns. Further advancements toward nuclear power plants GC QCMEHC constitute further shortening of conduit lengths by judicial enlargement of conduit diameters and globose major equipment, especially by resolved equipment deviations from globose forms MEHC functions, which inherently corrects conduit deviations. Advancements continued into Arts and Sciences QCMEHC complexities resolve infinitesimal deviations.

Prior applications drain-traps Universe forms and Sets extensively exemplify major differences in crafts/trades and more advanced construction and engineering disciplines finite to infinitesimal deviations from Arts and Sciences Sets and forms. ‘Substance’ must comply with the Laws of Mass and Energy and the First Law of Thermodynamics function mass energy preferred paths and patterns which superimposed over a tested ‘forms equals function’ Sets and forms must coincide with those of QCMEHC; the scientific communities failures to include atmosphere's fluids changing perimeters boundaries introduce fatal errors which the application GC Boundaries describes with extensive perimeter boundaries undeniable evidence.

Masses energy inventions, principles and methodologies must comply with said Laws ‘substance’ function and paths and patterns; otherwise any related subject matter aspect at best is in the realm of crafts and trades construction; ‘best operation’ applies vaguely but lacks common facts specifics persuasiveness.

Thus, separated reactor vessel and steam generators/separators closest proximity while in separate buildings allows for maintenance, replacement and longevity of one without impacting these of the others. For the same reasons imposing said equipment ‘functions’ into one are proven technologies century away. Clearly, said shrunk lower containment building part presents a flying projectile smaller, strengthen and a better fortified target, with the annex's floors, bays and equipment. Entire half of the annex building fully destroyed would not preclude the reactor's safe shutdown provided said building compartmentalized other half, analogous to naval vessels' pressurized compartments, is supplied in emergencies with cooling water to the reactor vessel head, below steam generator/separator high pressure pump exposed motors elevation.

Buildings separated/compartmentalized equipment ‘functions’ interconnect with said shortest and straightest conduits without limitation to their diameters, thus, primed for MEHC said conduit, equipment said inherent peculiarities' extent into conduits debugged analogous to mass energy ‘genome’ similarities. Thus, each fluid's retained, detained, transposed, transferred, or transported mass energy functions fastest turnovers is balanced, tuned, ‘genome’ methodologies/principles adopted, combustion engines analogous, inline two or radial four, herein, steam generators/separators. Mass energy inherent self preservation, self conservation readily conforms to any perimeter superimposed functions utilized energy, spent longevities, with a boundary mass energy dissipation eventually contributing to said gradation stratification processes. Fluids sealed perimeter boundaries, especially electromagnets electromagnetic fluids, thermal expansions, contractions free movements, allowed to repeat, during re-fuelling outages and lowest, especially bending moment, perimeter boundary stresses by said innovations constitute least energy, unavoidable dissipation.

Heating, ventilation, and air conditioning, HVAC, fluid, gases/air ‘substance’ mass energy, that is Laws of Mass and Energy Conservation with Thermodynamics MEHC linear paths conduits' transported, Globose Sets, forms retained, detained mass or transposed energy dissipated patterns unless superimposed ‘forms equal function’ enforces identical perimeter boundaries. In fact perfections do not exist, except for said ‘genomes’, which prove as rare as they are they are achievable in elementary ‘functions’ and ‘forms’. Forced ‘forms equal function’, Sets and forms superimposed over mass energy said GC paths and patterns must yield common perimeters boundaries or MEHC dissipates. Said shortest most straight conduits and containment penetrations correctly separate major equipment said functions, maintenance, or replacement with appropriate interstitial, maintenance, spaces. Thus, the reactor, annex, and turbine building buildings shortest most straight paths said inline two or radial four alignments is absolutely correct and points to the debilitating, upright steam generators/separators bug within the pressurized reactor present state of the art. The annex building readily provides space for horizontal steam generators/separators technologies that are available, with years of fossil fuel plants experience, as well; horizontal steam generators/separators better synergies significant savings, with said reactor building lower part, annex building height shrunk to a half of the present art building height, where said construction cut costs cut design, licensing, and construction periods time costs. This in turn cuts, along with cuts in valves, structural supports and restrains, electrical cable and equipment maintenance, interstitial, space, buildings, cuts HVAC gas/air fluids equipment costs construction and management. Radiation, excess pressure, in the reactor building, HVAC processes scrub or filter with clean air discharged. With a reactor building pressure overload, the annex building becomes a temporary reservoir; sealed annex building required access for maintenance should occur less frequently than required in the containment, with said buildings spaces also available with exception of control room and habitable space in the auxiliary building. The annex building's pressure increase has the containment wall said lower part in tri-axial compression, adding to safety and sealing of that containment part. Power plant's steam generation produces by electrolysis hydrogen and oxygen that easily temporarily store in the auxiliary or annex building. The HVAC should not, under any circumstance, allow these gases to escape; an insulation cylinder placed around the reactor shield wall avoids direct radiation heat into the steel liner.

Said four innovations to the present art steam generators/separators lead to the fifth. At the top of the steam generator/separator, a shell perimeter globose form replaces the steam line U-bend and encloses the steam generator separator uppermost part, to separate into a steam line extended downwardly to a trust block transmitted horizontal and vertical loads and shear stresses into the reactor, annex building common foundation. Steam generator/separator structural backstop enclosures transmit loads and stresses into said foundation consistent with the present art. A required structural lateral support from the containment wall to the steam generator/separator support attachment on opposite side with the support arms length thermal expansion equal to that of cooling loops outgoing legs. Said attachment at highest suitable floor elevation keeps a steam generators/separators position stay upright, necessitating removable horizontal brace across the reactor building refueling channel. Removed during refueling the brace with the reactor vessel head is stored temporarily on the reactor building said upper floor slab. Transmitted dynamic loads through floor slabs avoid banding stresses. Said horizontal generators/separators usage removes 180, 90 degree elbows.

Supra, least length high energy conduit lines' innovations lead to the eighth major innovation said high energy conduits' triaxial compressions achieved by said outer-spools, reinforcing-sleeves weldments that likewise simpler construct by the successive reinforcing-sleeves, outer spools welds, inline assembly; the reinforcing-sleeves or outer-spools either one or both can constitute welded halves. Spools and outer-spools constituted space pressurized with argon or other gases including air, or an electromagnetic turbine lubricating paste, or such similar fluids transfers in part spools hoop, vibration, peak, and bending stresses to the outer-spool which becomes sacrificial material repairable without causing an outage. Each separate space outer-spool has separate respective fluid inflow on top, drain on bottom threaded and capped portal.

Said ironclad annular enclosure multiple disks electromagnet heads, herein, face said annular ring inner radius and constitute mechanical, victalic coupling, herein, four bolts devices assemble in-place two halves around the outer-sleeves and their said structural insulation. Said electromagnets, victalic coupling devices rolled on carts with wheels locking device into a selected position electromagnetic force lock unto the outer-spool, said insulation, and spool as adjustable supports vibration damping devices for the piping. Sufficient electrical power, which magnetizes heads' coils, can make said spool, magnetic fluid, and outer spool a solid structural/mechanical spool member, transferred largest bending stresses to outermost fibers.

The ninth major innovation minimizes power plant structures and equipment energy of distortions that shorten plants longevities to maximize electrical power generation efficiency. In fact, this innovation summarizes supra innovations and known in the art theory of elasticity energy of distortion derived values that result from various stresses accompanied strains with strains in boundaries perimeter. GC boundaries perimeter hoop stresses minimize bending stresses and allowed thermal expansions least strains conserves fluids mass energy, reduces stresses/strains, for least distortion energy plant increased longevities. A least length path, straightest from the reactor vessel to the turbine/generator minimizes distortions energy taken out of fluid masses energy that otherwise generates electrical power. Said conduit innovations, said steam tunnel elimination, and said major equipment, herein, disclosed or inferred, major energy savings result in this innovation. The ‘disclosed, inferred’ includes the buildings revisions, equipment relocations, reduced stresses, and loads transmitted through floor slabs to foundation with least or no banding moment stresses.

Optimal mass energy paths and patterns electrical generation least energy of distortion constitutes the turbine building, reactor buildings common floor slab buildings and equipment the inline two or radial four configurations balanced tension/compression axially transmitted forces; said balanced configurations two or four tuned cooling loops' steam generator/separator branches include turbine buildings, condensers vibrations tuned column legs, foundations said axial stresses reduced, thus least banding moment stresses. Shortest path steam lines from the steam generator/separator to the turbine makes preferred elevation least difference from that of the cooling loops with wall penetrations as described for the containment building.

Said configurations allow for potential removals of the turbine peculiarity requiring an elbow into turbine casing from a steam line at a higher elevation. Said electromagnet fluids tuned anchor base plates, expansion joints least pipe stresses, and floor slabs removed banding stresses should eliminate the elbows.

Least lengths, allowed thermal expansion, least stresses especially banding, and spool/outer-spool double wall piping eliminates need for isolation valves as pipe break in this construction, not a double but a quadruple guillotine pipe break is not a viable concern; said liquids or electromagnetic fluids transferred said stresses make outer-spools uninterrupted operations repairable, sacrificial conduits, whose integrity is verified with remote control pressure sensors in said portal caps, which precludes a potential piping break. Except for equipment inflow, draining isolation outflows, and safety valves, said piping eliminates valves. Inherently unfailing gravity force underground aqueducts water flooded said annex building high pressure pump bay, compartment, and loop in a theoretical pipe break following site and aqueduct details describe.

Substance, matter, mass and energy, mass ‘function’ contains, retains its mass in globose ‘forms’; energy itself has transport ‘function’, fluids flow analogous energy instances constituted conduits ‘forms’. The sixth and seventh most significant nuclear power plants' innovations are site locations and elevations selection based on preferred water masses energy heat transfers from atmospheric precipitations, together with electrical power generation heat energy byproduct, into the Earth's crust locations. The present state art plants site selections seismic evaluations trend toward preferred seismic inactive locations. Also, here, said state of the art seismic evaluations and inactive preferred nuclear power plants locations apply to site least active seismic zones tectonic plates' centric portions, again away from major faults. Power plants at these locations transfer heat energy into the Earth's crust cooler masses, thus, away from fluids' hot spots, magma masses generally coming to the surface along plates' perimeters. The heat energy as power plants byproduct waste, in fact is used to cause tectonic plates thermal expansions toward said fault line closings eventual tectonic plates' expansions, closed hot spots reduced volcanic activities, the Earth's crusts sealed tectonic plates masses and perimeters, and cooler atmosphere. Prior application, QCMEHC underground aqueducts strategically locate paths from proximities of their water sheds to seas or oceans. Said strategic paths most centric, sufficiently underground cooled aqueducts' water masses, tectonic plates' most centric locations represent preferred nuclear power plant sites. Thus, the site globose ‘form’ contain, retain mass ‘function’ strategic fluids, water aqueducts, magma masses heat energy linear, radial heat energy transfers respective transport ‘functions’ intersection; site selected nuclear power plant is globose-conduits serial or successive, formations perimeters boundaries, engineering disciplines highest conserved mass energy Sets and forms energy patterns strategic paths location inside an advanced mass energy processor that is Earth.

Said selected nuclear power plant complex reactor vessel head sets a natural water level elevation based on incoming aqueducts water level elevation flooding said annex building compartments and a bay. Said elevation gravitational force MEHC pushes once-through turbines' condensers cooling water system.

The tenth major innovation encircles nuclear plant's complex into a globose perimeters boundary, bentonite slurry wall extending from bedrock, significant depth, or an impermeable soil layer to a berm or a levee crest absolutely precluding flooding into site perimeter; inside the perimeter the groundwater level is held below the reactor building foundation, with a network of perforated field tiles sand filters and filter fabric encased draining into a reservoir where two pumps each with a capacity to preclude a ground water rising; reservoir groundwater is tested and if needed scrubbed prior discharges through aqueduct network.

The slurry wall is also expansion joint filtering out plant site most damaging seismic longitudinal, compression waves by allowing energy dissipation with displacements inside bentonite slurry thick walls. This seals groundwater, with even groundwater inflows into said site perimeter a remote possibility, only. Site locations distant from quake epicenters greatest concern are seismic longitudinal compression waves. Slurry walls, berm least thickness for a required depth construction alongside aqueducts sufficiently away not to degrade compacted subgrade into and from the turbine buildings positively seal said site from water inflow; the aqueducts slurry walls as two more seismic compression waves isolation, fluids inflows sealed joints positively isolate and avoid an underground and uncontrolled mass energy inflow into the plant site.

The reactor, annex buildings eleventh and twelfth major innovations constitute a cup and a saucer foundation with the buildings as the cup. The saucer constitutes a thick reinforced concrete slab anchored in bedrock or bedrock anchored caissons supported said slab; closely spaced radial ribs in the slab's upper surface extend radially from the slab center into a foundation perimeter wall facing saucer's rim wall with buttresses. Said outer saucer wall face has buttresses radial directions aligned with said horizontal ribs on said walls, as buttresses that anchor into bedrock, or in the caisson foundation into compacted backfill and the saucer slab; a Teflon sheet sandwiched between two stainless steel plates on top of the slab horizontal ribs upper surface has sufficient depth, between said ribs, to said plates height of medium and fine grained angular sand compacted in excess of 95% relative density. Cardboard encased dry bentonite sheets cover the sand backfill between Teflon sheets and covered with polyvinyl plastic sheets that preclude a moisture penetration into the backfill during construction, especially during concrete pours. Said reactor and annex building floor slab and foundation wall are poured against the saucer perimeter wall that is lined with said bentonite sheets, thick Styrofoam, and said polyvinyl sheets which precludes again a moisture penetration to the bentonite. Said construction further includes rectangular ducts, vertical shoots, between said saucer and buildings foundation walls entirely radially buttresses aligned, for said saucer foundation entire height to grade elevation; stranded stainless steel wires' lengths lower continuously spaced elastomeric-pads into the shoots, to the foundation slabs and said annex building floor slab elevations. Space voids between the saucer and cup foundation walls and in-between the shoots are filled with fine clean sand; soft compacted clay fill of at least several feet, sloped for surficial water to drain away, protects said spaces' construction.

The nuclear power plants thirteenth, fourteenth, and entire technology major innovation constitute a stainless steel water ‘tower’, globose-dish truncated at grade level for its functionality; said globose-dish has required water holding capacity and stainless steel liner integrity structural, maximum allowed cutouts reinforcement stiffener ribs, grade beams, and diaphragms that permit water flowing through but preclude splashing, especially in a seismic event; highly streamlined ribs, grade beams, and diaphragms for laminar flows constitute said globose-dish QCMEHC. The subgrade soil adequacy, soil borings verified, removes any unsuitable material; a compact backfill as a part of structural foundation must exceed 95% probability of exceeding 95% of relative density and consist of clean, well graded coarse gravel; coarse, medium, and fine sand. Stainless steel liner over the grade beams and diaphragms encloses the dish and allows backfill and heavy equipment traffic over the dish. The entire construction including the compacted backfill must constitute 115-120 lbs/ft³ density well compacted-soil ‘floating foundation’ with entire structure including backfill, equivalent to the weight of soil removed. Water into said dish comes from closest aqueduct, in a gravity flow, through a pipeline at grade; one or more underground pipelines through a short length, width and height tunnel from the dish into said annex building bays compartmentalized enclosures supply flood-water volumes needed. Cork or rubber flexible backing material seals pipe penetrations through said cup, saucer annex building wall, with mastic and supra cocking sealers. Instead of said backfill with vehicular traffic loads over the dish, cooling towers supported by said stainless steel construction, grade beams with diaphragms, as a replacement, is an option that provides equipment cooling water by gravity and also cool said compartments or bays; in that option a return pipeline into the globose dish at grade must include the annex building pump, said walls' sealed penetrations and water dish capacities that allow for evaporation.

Said aqueduct is cooling water inflow into the plant site that allows for said pipeline at grade that fills the globose dish by gravity. The globose dish may constitute a protective liner interface between said backfill and stainless steel. Among available liners is fiberglass sheeting location spliced, a concrete liner poured on site. The return pipeline utilizes said tunnel. Said penetrations flexible sealers, including those of the present art, must preclude a potential for a double guillotine pipe break requiring appropriate repair, replacements inspections program addressing unusual, unexpected events not limited to earthquakes only. Said water supply below frost line, insulated conduits with high velocity flows otherwise entirely drained, and operational highly heated water from major equipment cool-down preclude the water supply freezing.

Most critical resource cooling water is preferably contained in aqueducts; current art technologies apply, also; in either utilization most precious resource huge quantity requires government authorizations.

Nuclear power plants advanced designs constitute said GC QCMEHC least lengths, straight paths conduits, reactor vessels, horizontal steam generators/separators, and turbines/generators, present states of pressurized or boiling water reactor further revised technologies; the advanced technologies constitute the high-pressure steam nozzle in a short conduit length from said steam separator to the turbine, thus causing back-pressure increase into steam separator sole function; the boiling water reactor technology steam path is directly from the reactor vessels without generators/separators to turbines, which requires sealed turbine building radiation control. The nozzles' created back pressure in boiling water technology configurations extend through steam separator sole function raises reactor vessel's water boiling point temperature that is a basic pressurized configuration concept made possible by supra innovations, especially by the described expansion joints; further superheating steam by compartmentalized electric heating filaments immediately prior and passed the nozzles again raises back-pressure and water boiling point temperature. Said primary loops eliminated pressuriser has construction cost savings. Said electric heating elements provide for pre-heating the expansion joints to their closed positions and highly accurate steam pressure, temperature, and moisture contents quality delivered to turbines. Said innovations call for reviews that should eliminate the elbows presently required for steam inflows into turbines making supra innovations even more beneficial. High-energy steam lines energy is from the common source, the reactor vessel, and thus should constitute equally split directionally balanced energy transport; the heating filaments raised steam temperature at the nozzles' allows for back pressure controls through entire system, constituting highly balanced tuned plant.

Reactor building containment penetrations, with said steam generators/separators separated out of the reactor building into the annex building as the major most significant innovation, have another option. Said structural insulation, with uniform widths narrow gaps ferrous-plates lined cylindrical circumference electromagnetic spools have wound wire over the plates, coil-length through which electric current passes magnetizing the plates whose ends turn outwardly into bracketed-plates that in installed position butt into a contact with the ferrous flange; the ferrous outward-bracketed plates, as structural members individually welded to a stainless-steel tube inside diameter transfers electromagnetic forces resisting the pipe motions to the tube whose length approximates the reactor building composite thickness with steel sleeve through, in the reactor building's wall; same lengths, narrow, symmetrically spaced structural boxes subdivide said tube perimeter; the boxes with three sides have adjacent pairs welded edges and welded to said tube make boxes which constitute only three sides, which with the tube slide into the containment penetration sleeve. The forth side, allows an elastomeric rubber/stainless-steel pads having matching sides dimensions tightly fitted between the sleeve and the tube, with the stainless-steel plates placed top and bottom with the plates abutting the tube, sleeve matched respective radii for elastomeric pad plate materials uniform thicknesses.

Universally exhibited mass energy formations paths, patterns and forms are the Laws of Mass and Conservation ‘function’ phases of ‘forms equal function’, Universal evidence constituted energy preferred linear path conduit and mass globose forms. The ‘forms’ part and the ‘function’ phase to ever larger mass devise and merge globose-conduit forms Universe by ‘superposition property’-‘superposition principle’; the GC, globose-conduits, simultaneously exist with the Laws of Mass and Energy ‘substance’ or matter’.

Accordingly, said plant site controlling mass energy inflows, outflows largest perimeter boundary is a bentonite slurry-trench, encircling wall, with fluids-energy, air masses, aqueducts water, precipitation, groundwater, seismic, heat energy subsoil interactions, electrical power, and fuel/waste inflows, outflows. Only correctly sited, millennium lifespan of nuclear power plants can preserve this planet's living species.

Equipment inflows/outflows ‘forms’, ‘function’ series configures from the reactor vessel and said steam generators/separators, to the turbine generator multiple primary coolant and steam loops and in said series succession the containment, annex, auxiliary, and ancillary buildings perimeter boundaries. Two or four mass energy loops originate from the reactor vessel by superposition. Multiple and serial enclosures perimeter boundaries' formations, constitute the light water reactors pressurized system GC conduit tuned piping mass energy processes and buildings complex, boundaries safely closed perimeters. Said mass and energy processes ‘forms equal function’ constitute crafts and trades processes configuration of the present art to engineering sciences converted balanced and tuned to closest possible MEHC configuration conduit piping freed, to greatest extent, from major equipment crafts and trades construction process peculiarities.

Accordingly, the Earth's processes degraded energy brief synopsis discloses the following points:
there is no ‘renewable energy’ as such energy has ‘dead end’ that will track oil and gas shortages history;
geothermal energy cools the Earth's mass magma, fluid, that generates the Earth's electromagnetic field;
wind power energy slows atmospheric circulation, Earth's rotation wherein either cuts Earth's longevity;
solar energy lacks energy grids, damages magnetic field and is 50-100 years into Earth's ‘tipping’ point;
nuclear power has chance to preserve or substantially increase Earth's longevity but costs are enormous;

The Earth is an advanced mass energy processor. Enormous energy is needed to reverse, at least, in part damages done, with the atmosphere accumulated enormous water vapor, ‘greenhouse gases’ mass. The Earth's eroded river beds have drastically lowered continental ground water levels, which in part was masked by melting of polar caps; however, both processes took cooling fluid from the Earth's surface and supplied the tropical belt's water for more rapid evaporation; said Earth's more rapid water evaporation to cool itself will fail because of enormous water vapor accumulated in the atmosphere whose mass is forced into radiation, irradiation heat energy retained which continually forces more evaporation. Said processes cannot themselves rebalance the Earth's, the atmosphere's water fluids imbalance unless the atmosphere's suffers a partial blow-off. In fact, partial blow-offs are regularly occurring but thus far are insignificant in magnitudes and, if fact, are the Earth's energy processes most valiant efforts to preserve living organisms.

We should phase out all major energy generations accept for judicial utilizations of nuclear power that requires underground water GC aqueducts heat transfer of into the Earths crust best effort to preclude the Earth's magnetic field further deterioration while using most efficient energy generation technologies.

Said nuclear power plants convert crafts or trades to GC MEHC processes, technologies electrical power generation-one strategic locations integrated plants site inside the Earth's mass energy forms, paths and patterns constitute inside the Earth's, the atmosphere's advanced processor natural energy processing; said processing minimizes unavoidable, inherent perimeter boundary stresses and fundamentally avoids or minimizes banding stresses, vibration magnitudes, tunes piping conduits, structural supports, and building penetrations for no resonant frequencies response; the reactor vessel superimposed balanced inline two or radial four alignment is equipment generated energy processes, buildings complex of centric construction.

The GC MEHC arts and sciences nuclear power plants innovations, principles and methodologies disclosed processes and devices constitute ‘shovel ready-green technologies’ that require minimal reviews by overseeing agencies. Capital investments per turbine/generator complex are most likely one half of the present art costs with simplified reactor building lower height with horizontal steam generators/separators enormously shrunk lower part and eliminated steam tunnel and double-wall piping eliminated high energy piping/steam lines isolation valves. On the other hand, per site's electrical generation doubles, quadruples for respective two, four energy loop configurations, with loops' conduit piping shortest lengths, especially from the reactor vessel to steam generators/separators that allow greater pipe diameters. These equipment peculiarities corrections allow for greater mass cycle turnovers toward reactor vessel, GC QCMEHC, fuel and control rods reconfigurations greater heat energy processing or greater generation of electrical energy.

With interstitial, maintenances, space improvements through elimination of said steam tunnel and extensive supports that were required to control piping heat and energy displacements extends longevities of structures and systems and provides for their time maintenance, also; with said minimized unavoidable, inherent stresses plant's life millennium expectancies are reasonable along with major equipment planned and expected rehabilitation and replacements that include steam generators/separators and reactor vessels.

The globose-conduit, GC, herein innovations, principles, and methodologies are expected to drive that project's longevity electrical power generation cost per kilowatt-hour by the two orders of magnitude.

The fifteenth major innovation constitutes said strategic locations integrated plants site, advanced processor natural energy processing, least stresses, most stable double-wall piping conduit and slurry wall most stable triaxial compression perimeter boundaries millennium longevity, which essentially solves the spent fuel disposal/repository; first, because a developed site becomes and will continue as most valuable energy generations' assets that continue to develop through innovating replacement technologies, beyond said millennium longevity. Second, the site is entirely secured against fluids leakage constituting an ideal reprocessing of nuclear waste location. Third, with the nuclear waste reprocessing improved technologies making reprocessing profitable, minimal radiation waste shipment from the site to a repository will occur.

Mass and energy has ‘forms’, ‘function’, and ‘substance’; present innovations' licensing as utility patents ‘forms’ reflects the globose formations of the atomic chart elements; the ‘function’ is undefined or infinite, because the Laws of Mass and Energy Conservation are excluded; the ‘substance’ part constitutes ‘forms’ and ‘function’. ‘Substance’ or matter forms in instances of photographic snap shots, static images are those of said atomic chart table as most elementary; in time and space ‘substance’ constitutes dynamic globose conduit, GC, globose-conduit, forms; ‘substance’ excludes any potential for differences or errors. The GC enormously powerful when included within innovations, principles and methodologies are rooted in common origin with the ‘substance’ omnipresent said Laws ‘function’ Universal forms, paths, patterns.

Mass-energy equivalence concept mandates existence of globose and conduit equivalence as each must have originated from a same ‘substance’ whole at a same time begs the question what the whole and the time are, and what was before that? Bose-Einstein condensate yields elementary histories, as it is not a solid or liquid. The globose atomic elements near the absolute zero temperature change into string forms, with curled ends. A laser light-velocity slows as it travels through said supercooled condensate's mass or ‘substance’ static very unstable images of elementary atomic forms. They too must have said same origin and said Laws ‘function’. There is only one unification concept for all of the above. At said temperatures the atoms unfurl themselves from a globose mass toward a conduit mass form in incomplete processes, as said unfurled atoms mass still makes curled ends. In the incomplete processes, globose mass change from almost entirely unfurled to conduit energy linear forms must have controlled condensate's further cooling, which is most likely a virtual impossibility and may require cooling below absolute zero, an impossibility. However, at condensate entirely unfurled ends, the atoms as conduit linear energy forms minimize further interstitial spaces which would further slow down any form of energy passing through. At the point when mass changes to energy, fusion of condensate mass-energy makes it a whole, which blocks passage of any energy including light; ‘substance’, ‘forms’ and ‘function’ Universe ‘black hole’ and ‘big bang’ originate. Thus, ‘black hole’ and ‘big bang’ Universe is generic, genetically imprinted mass and energy relationship; ‘substance’ GC ‘forms’ enormous significance is on par with the Laws of Mass and Energy Conservation.

The globose-conduit enormous importance in predicting ‘substance’ unfurled ‘functions’ suggests the scientific smallest ‘God's particle’ pursuit is unbridled irrational exuberance. Unfurling of mass into a conduit energy form discloses infinitesimal mass unit transformation into smallest energy unit which seek to merge with closest much larger mass-energy form leaving behind a void or a vacuum; in these contexts electrons are remnants mass portions shrunk from much larger mass portion with infinitesimal mass and a respective energy electric charge of a much larger particle; in mass-energy breakups, a very large portion converted to energy conduit forms after a continuous no interstitial-space mass ‘big bang’ breakup caused Universe of atomic mass and energy conglomerates. With our understandings of a uniform homogeneous solid, a breakup in a globose mass occurs with said solid material imperfections with stress concentration. A ‘black hole’ enormous triaxial compression maintains the globose shape unless severe bending stresses occur that cause distortions; a failure or a breakup has presence of both, stress concentrations and material impurities or imperfections. In a ‘black hole’ big bang, such failures phenomenon are natural, accidental or intentional. Searching for smallest particle mass, unit of energy, while important must yield priority to—of the three, which one? Followed by who/what/why/where/when? Especially for said last, or the third. Should the Laws of Mass and Energy Conservation hold up in ‘black holes’, mass-energy ‘substance’ will continue merging processes ‘function’; merging and breaking cycles will continue until repeated stressing and material merging removes imperfections with said gradations, stratifications as preliminary processes.

GC ‘forms’, the Laws of Mass and Energy Conservation, or ‘substance’ ‘forms’ and ‘function’, in a short or a long term, with a continual demand for more energy, all geological history, environmental and space data, evidence show that on a global planet preservation level and on universal level combat against said gradations, stratifications processes demands nuclear power processes response. Said generation-one nuclear power plant processes transfer crafts and trades into engineering technologies or MEHC first steps toward ‘substance’ QCMEHC ‘forms’ ‘function’ superimposed by nuclear power generation ‘forms’ with ‘functions’ to infinitesimal perimeter boundaries differences. Said MEHC or QCMEHC implementations make the breeder reactor more viable technology with said conduit innovations, site, major equipment and building configurations mass energy processes. Of particular importance is said unfurling of atoms which makes initial fusion step toward its cleanest energy generation processes. The GC innovations, principles, and methodologies electrical power generation processes starting with environmentally most friendly said generation-one power plant configuration is critical first step, leading toward such plant versions to come. Applying Moore's Law, here, has same investments in successive equal time intervals doubling electrical power kilowatt-hours generation, with plants new versions time intervals greater than those of processors; accordingly, ‘global warming’, ‘national energy independence’, and conservation of most valuable natural asset or lack thereof, water, are three prongs of stratifications, gradations processes constant, steady attack on this planet's survival; generation-one plant, nuclear energy, processes least contribute to stratifications, gradations processes, promise ‘global’ and ‘national energy independence’, combat ‘global warming’, and underground aqueducts heat transfer into the Earth's, fluids mass energy processes least mass transfer into atmosphere and cosmos; the generation-on plant heating crust processes retain Earth's fluids mass energy, environment, magnetic field strength, and life longevity on planet, which otherwise are gravely imperiled. Supra provides many specificities that should not limit, nor construed as limiting, the scope of the inventions, innovations; they merely disclose mass energy conservations ‘substance’, preferred ‘function’, ‘forms’ and processes system ‘functions’ ‘forms’; superposition into most coincident perimeter boundary confirms preferred GC MEHC and/or most preferred QCMEHC configuration. Those skilled in the art of designing nuclear power plants and in the art of electromagnets and electromagnetic fluids may find many details that are without drawings, for as such they are most elementary or basic, thus known in the are and not required. The GC inventions, innovations, principles, and methodologies constitute infinite variations of components, arrangements, and relationships without departing from the scope of disclosed inventions, innovations, principles, and methodologies; for example, crafts or trades configurations transpose through GC principles and methodologies to a GC MEHC, to the Arts and Sciences GC QCMEHC and vice versa.

Supra nuclear power plant crafts and trades Sets, forms conversion to engineering disciplines said GC MEHC primary loop coolant fluids constitute water or steam lines mass energy most positive entirely stable perimeter boundaries; the coolant fluids, water, site groundwater, underground aqueducts and water gravitational force supplied into the site and primary and steam line piping loops constitute said crafts and trades conversions to engineering disciplines GC MEHC Set forms; the underground aqueducts, globose-dish, and conduits gravity force laminar flows entirely at atmospheric pressure in their uppermost portions constitute most preferred QCMEHC forms. Only the most rare, highly artificial, created entirely uniform, homogeneous fluids, and entire cross-sections hydrostatic pressures MEHC, prefer entirely round conduit.

From a common point, reactor vessel, ‘substance’ fluids' mass energy radial, parallel, two or four superposition paths, preserved processes self-conserving and imprinted generic ‘function’ globose ‘forms’ (major equipment) contain, retain, detain, transpose or separate said mass energy, wherein the ‘substance’ imprinted generic ‘function’ any mass energy transport prefers imprinted ‘conduit’ forms; the ‘substance’ nuclear fission crafts and trades major equipment transpose their conduits transfer into electrical mass energy to transmission line ‘conduits’, thus GC, globose-conduit, forms. Said reactor building subdivided into three ‘forms’ three ‘functions’: the reactor vessel and a loss of fluids in an accident containments, and safety equipment annex building globose forms having crafts and trades conduits configure into balanced and tuned ‘forms’ perimeter boundaries millennium longevities, with electrical power generation costs cut by two orders of magnitude. Reconfigured buildings and conduits forms resembling ‘substance’ preferred forms, MEHC paths, and patterns are expected to cut initial construction costs by a half while doubling or quadrupling power generation, thus two or four turbine buildings making for longevity enormous savings, as well as solutions for nuclear waste disposal. The QCMEHC innovative globose-conduit, GC, globose-dish processes entirely coolant related overlaps into support equipment safest operations. Electromagnets, electromagnetic fluids, power supply, GC forms least stresses perimeters, and triaxial compressions safest longevity, including slurry trench globose form, allow replacements and maintenance secured boundaries.

Mass energy device superimposed ‘substance’, ‘function’, ‘forms’ confirm aforesaid innovations; atomic processes, including robot assisted reactor vessel replacement, fundamental small electrical energy amount seals with permanency perimeter boundaries which retain, catch fluids mass-energy, solve ‘global warming’, water conservation and constitute the national/global energy independence only available path.

### BRIEF DESCRIPTION OF THE DRAWINGS

Supra provides many specificities that should not limit, nor construed as limiting, the scope of the inventions, innovations; they merely disclose mass energy conservations ‘substance’, preferred ‘function’, ‘forms’ and processes system ‘functions’ ‘forms’; superposition into most coincident perimeters boundary confirms preferred GC MEHC and/or most preferred QCMEHC configuration. Those skilled in the art of designing nuclear power plants and in the art of electromagnets and electromagnetic fluids may find many details that are missing but verbally described in sufficient detail to confirm their validity and innovations. Atomic processes include robot assisted reactor vessel replacements; fundamental, small electrical energy amounts seal with permanency perimeter boundaries which retain, catch fluids mass-energy, solve ‘global warming’, water conservation and constitute the national/global energy independence only available path; restated enormous global and national interests, herein, we claim mass and energy conservation processes.

### DETAIL DESCRIPTION OF THE DRAWINGS

Supra provides many specificities that should not limit, nor construed as limiting, the scope of the inventions, innovations; they merely disclose mass energy conservations ‘substance’, preferred ‘function’, ‘forms’ and processes system ‘functions’ ‘forms’; superposition into most coincident perimeters boundary confirms preferred GC MEHC and/or most preferred QCMEHC configuration. Those skilled in the art of designing nuclear power plants and in the art of electromagnets and electromagnetic fluids may find many details that are missing but verbally described in sufficient detail to confirm their validity and innovations. Atomic processes include robot assisted reactor vessel replacements; fundamental, small electrical energy amounts seal with permanency perimeter boundaries which retain, catch fluids mass-energy, solve ‘global warming’, water conservation and constitute the national/global energy independence only available path; restated enormous global and national interests, herein, we claim mass and energy conservation processes.

1. Globose-conduit (GC) perimeter boundaries formations mass energy highest conserving (MEHC) Sets, balanced nuclear power plants, in millennium lifespan generate safest environmentally most friendly electric power; said perimeter boundaries' formations, multiple and serial enclosures, constitute a globose foundation globose reactor vessel, a containment building with a lower perimeter ancillary annex building for multiple primary coolant loops, light water reactors pressurized system, GC conduit tuned piping mass energy processes and buildings complex, boundaries safely closed perimeters; two or four globose steam generators/separators two or four high pressure pumps' coolant loops and the reactor's support equipment floors in the annex building outside of the containment symmetrically align high pressure and temperature GC MEHC boundaries respectively two or four processes generated electrons turbine-generator buildings; the reactor, steam generators, processes piping and turbine-generators make GC mass energy formations; atomic processes including robot assisted reactor vessel replacements fundamental small electrical energy amounts seal with permanency perimeter boundaries which retain, catch fluids mass-energy, solve ‘global warming’, water conservation and constitute the national/global energy independence only available path;
from a common point, reactor vessel, ‘substance’ fluids' mass energy radial, parallel, two or four superposition paths, preserved processes self-conserving and imprinted generic ‘function’ globose ‘forms’ (major equipment) contain, retain, detain, transpose or separate said mass energy, wherein the ‘substance’ imprinted generic ‘function’ any mass energy transport prefers imprinted ‘conduit’ forms; the ‘substance’ nuclear fission crafts and trades major equipment transpose their conduits transfer into electrical mass energy to transmission line ‘conduits’, thus GC, globose-conduit, forms; said reactor building subdivided into three ‘forms’ three ‘functions’: the reactor vessel and a loss of fluids in an accident containments, and safety equipment annex building globose forms having crafts and trades conduits configure into balanced and tuned ‘forms’ perimeter boundaries millennium longevities, with electrical power generation costs cut by two orders of magnitude; reconfigured buildings and conduits forms resembling ‘substance’ preferred forms, MEHC paths, and patterns are expected to cut initial construction costs by a half while doubling or quadrupling power generation, thus two or four turbine buildings making for longevity enormous savings, as well as solutions for nuclear waste disposal; the QCMEHC innovative globose-conduit, GC, globose-dish processes entirely coolant related overlaps into support equipment safest operations; electromagnets, electromagnetic fluids, power supply, GC forms least stresses perimeters, and triaxial compressions safest longevity, including slurry trench globose form, allow replacements and maintenance secured boundaries;
mass energy device superimposed ‘substance’, ‘function’, ‘forms’ confirm following innovations;
in innovations to the current art, herein mass energy globose perimeter boundary GC forms' hoop stresses strategically substitute for conduit banding stresses, which avoids a piping spool's elbow or bend; furthermore, piping loops expansion joints provide required system integrity preferred axial loads utmost reduced stresses, entirely avoids banding stresses, and thus, significantly prolongs power plants' life span; the reduced, avoided stresses conserved mass energy thus systems retained away from said stratifications gradations processes not only prolongs plants life span but is entirely utilized, thus boosting plants' power generation capacities; the conserved mass energy is primarily retained in the primary coolant recirculating loops resulting in mass energy loops higher circulating rates, nuclear fuel cells rods increased cooling that allows for higher energy fuel rods; further, expansion joints relieve thermal axial stresses causing flexing elbow or shell perimeters, longevity preferred bending stresses less than 15% of building codes allowable;
accordingly, GC fluids mass energy piping loops two, four (or multiple) diametrical branches are symmetrical about the reactor vessel, each recirculating reactor cooling water aligns containment building penetrations, the annex building reactor vessel steam generators/separators thus forcing thermal expansion joints; each steam generator/separator has its high pressure pump which returns recirculating water to the reactor vessel; said loops outgoing legs straight piping spools align equipment symmetrical configuration radially extending from the cylindrical reactor vessel and reactor building into said circumferential annex;
symmetrical, radial, diametric coolant loops, mass energy, heat the GC Sets process into electrical power;
reactor building piping penetrations, structural restraints constitute one of these expansion joints:
inorganic fullerene coated surfaces thermal expansion/contraction prestressed expansion joints,
multiple perimeter enclosure inorganic fullerenes coated surfaces, prestressed expansion joints,
structural mechanical electro-magnetic damped vibration frequency confined expansion joints,
structural, dynamic electro-magnetic field damped vibrations naturally sealed expansion joints,
high hydraulic pressures structural, prestressed, electromagnetic, energy-pipe expansion joints;
the reactor building wall penetration constitutes a stainless steel sleeve through the wall; a flange and a counter-flange on the wall respective inside, outside faces bolt together by two rows of bolts equally spaced and closely spaced two concentric bolt circles; boltholes lowest drilling-tolerance clearances allow bolts through piping loops' legs flange, counter-flange, with adequate separation from the reactor building penetration steel liner, allows for high energy pipe thermal movement; here, the loop piping outgoing leg horizontal centerline thermal expansion remains vertical, no horizontal components at said penetration, as the piping expands radially from the reactor vessel; the flange, counter-flange machined MoS₂ inorganic fullerenes, IF, large diameters, coated back face bears against an annular-disk respective IF coated surface having concentric grooves, clear of bolt-holes for pressure packed lubricating, turbine paste under torqued bolts pressure, each grove a permanently packed seal in the lubricated IF surfaces interface that allows for said thermal movements; each annular-disk bears against structural insulation, to in turn, bear against the reactor building steel liner respective face; a structural insulation spool, with drilled bolt-holes lengthwise through said spool heavy wall machined thickness, fits snuggly between the flange and the counter-flange through (with required clearances) said steel liner, liner insulations and annular-disks; said bolts, through the flange, the insulation spool, and the counter-flange, assemble with washers at each end bearing against the respective flange, counter-flange, a nut, and a lock-nut torque tensioned; the containment flanges, the disk-plates, and the steel liner structural insulation fully bear with more than sufficient surface area thus is affixed to the reactor building steel liner; backing-ring welded to the steel liner around flange, counter-flange has its outstanding edge radially turned inward into a lip to retain the liner insulation with adequate thermal separation from the annular-disks; and each likewise makes a penetration structural stiffener; the liner insulation entire thickness surface area bears against its respective backing-ring width precluding the insulation, the annular-disks slip; the insulation, annular-disk tongue and groove matched bearing surfaces affix interfaces; ring inner-face/turned-lip stiffeners/insulation bearing precludes insulation rotations, also;
said structural insulation spool snuggly fits the stainless steel sleeve outside diameter, in-between the annular-disks, at optimal thermal expansion; the annular-disk boltholes slight vertical-slots allow for loop's leg centerline, the reactor vessel synchronous vertical thermal movement; the flange bolt-holes can have small caulking countersink under oversized washers, with Thermeez 7030 or similar fireproof sealer;
the stainless steel sleeve inside diameter machined surface 5-10 nanometers thick IF coated, with the welded flange is preheated and slid-over machined respective loop IF coated straight spool; the spool and sleeve and said flange/counter-flange, annular-disks inorganic fullerenes surfaces seal the penetration;
a second-joint invention makes the annular-disks boltholes oversized, housed, instead of slotted to allow the return legs' respective movements; instead of boltholes allowed, said biaxial thermal expansion movements two or several stacked annular-disks, as subsequently described base plate invention provides;
bolt and stud connection assemblies must include washers under the member that is torqued; the safety related bolt and stud, housed slotted or oversized holes assemblies, require their respective tensions statistically sampled during each refueling outage verifying 100% compliance; calcium silicate ZIRCAR characteristics, insulation workability, fabrication, and properties exemplify structural insulation required; radial thermal expansion coefficients differences for stainless steel, structural insulation and steel require aforesaid space-gap sealer; the flanges, structural insulation, and counter-flanges bolted connections do not limit pipe penetration longitudinal thermal movement occurring between the pipe spool and its sleeve;
the aforesaid inorganic disulfide fullerenes MoS₂ (or WS₂) coated surfaces and housed boltholes, prestressed thermal expansion/contraction joints, supra two major innovations to the current art permit the energy-pipe mechanical electro-magnetic flux confining-dampened structural expansion joints as the third major innovation; annular ironclad electromagnet coil housing welds to said containment liner back face, which also includes radially welded penetration stiffeners around each of piping penetrations; half-sleeves matched pair of sufficient length bolt together around the pipe and its structural insulation; the half-sleeve equally spaced arms around circumference radially extended from their sleeve welds to respective annular soft iron disk plate backside, having a face to face head contact with the electromagnet's head flat surface; in difference to electromagnet clutches/breaks known art, said magnet's head surface restrains any motion when current passes through the coil magnetizing the head with mass of steel liner an enormous heat sink;
the third major invention ironclad annular enclosure constituted of magnet multiple disks welded side by side into the annular iron enclosure allow electromagnet disks' common or individual utilizations;
combining supra three into the fourth major innovation has said reactor building liner penetration circular opening reinforced at each containment penetration, with a short sleeve through the liner, groove-welded both sides, containment's face flush; said annular ironclad coil electromagnet enclosure face flush with said liner face is radial longitudinal stiffener sides full length both faces groove-welds attached to the sleeve; a backup-flange annular-disk T-flange shape, with one flange rim groove welded to said steel liner has the other flange rim as the insulated supra backstop and said flange; said structural insulation entirely encloses said electromagnet(s); electrical fireproof conduits preclude fire damage to said electromagnet's power lines; again, an electromagnet ring make-up of the abutting adjacent electromagnet disks welded in an annular-disk ironclad electromagnet enclosure substitutes for said annular-disk electromagnet, with the annular enclosure electromagnet-disks, operating as the individual, joint, or any one of disk combinations; an iron, annular-disk as the flange or as welded face of said stainless steel flange facing its electromagnet insulation thicknesses separated, the ubiquitous, preferred electromagnets heads annular-disks natural and electromagnetic field/fluid dynamics dampen vibrations' responses of said sealed, tuned expansion joints;
electromagnetic fluids change their viscosity in proportion to the applied magnetic strength; thus, the viscosity is controlled dynamically, which allows for active damping; electrical energy small amount controls mechanical energy large amounts, for highly controlled very efficient vibrations' control method; magnetic fluids viscosity, stiffness, adjust in milliseconds over frequencies and temperatures wide ranges;
the turbine lubricating paste utilized as oil base in an electromagnetic fluid having extremely fine soft iron grains, instead of aforesaid pure paste, is an innovation that continues the forth major innovation;
the flange, the annular-disk aforesaid concentric grooves a vertical groove connected, substantial distance from anyone bolthole, connects through the annular-disk angled, mainly vertical hole, a fireproof conduit, through supra described insulation, backup ring to an electromagnetic fluid container implements an electromagnetic fluid innovation; the container, attached to containment building liner, in the magnetic field when the energized magnet does not permit flow or when the paste is insufficiently heated to change into a fluid state, controls said fluid flow during plant operations or intentional electromagnets shutdowns;
aforesaid two implemented innovations combined into the third have the soft iron annular-disk at least in a part as the electromagnetic fluid container that connects to the flange, annular-disk vertical hole;
a preferred, near future most advanced expansion-joint embodiment as the fifth major innovation has the annular ironclad electromagnet's heavy housing groove welded to the containment steel liner both sides making the housing an extension of the liner; said stainless pipe spool steel sleeve with IF interface has insulation retainer-disk short height (relative to the insulation thickness) stainless steel flanges welded to the sleeve, at sufficient distance away from its near flange or counter-flange; retainer-disks retain supra structural insulation machined spool, with its inside diameter with precisely same diameter as the sleeve's outside diameter at operating range highest temperature; a machined, soft iron (stainless-steel as option) thin-wall (fraction of the insulation thickness) tube is imbedded concentric in aforesaid retained, structural insulation spool with a separation at each end from the retainer-disks; wound wire coil upright axis makes a line of symmetry for the entire assembly; a flange, counter-flange inside diameter very close machined tolerance assures the flange and the electromagnet's housing unimpeded full face to face continual contact that avoids electromagnetic paste leaking; under electromagnets effects said iron pieces obtained degrees of permanent magnetism preclude electromagnetic fluid leak; in containment pressure buildup, the flange presses against the electromagnet housing and iron pieces through time reverting to a natural magnet state positively seal the containment penetration and positively absolutely when the electromagnet is energized; the electromagnet's ironclad housing constituted flat disk faces are machined and covered with deposited five to ten nanometers thick flange, counter-flange extremely flat layer in contact with similar layer of IF, MoS₂, WS₂ or similar iron based inorganic fullerenes' coats; said housing entire surfaces and said flanges electromagnet's permanently magnetized assembly natural, permanently and strongly maintain enclosure, especially with the electromagnet energized; electrical power preferably provided through a metal conduit connects to the electromagnet's housing on the annex building side; provisions for the fluid supply, drain are through counter-flange respective highest, lowest elevation to fluid enclosure access, inside the annex; the electromagnetic fluid enclosure consists of flanges on sides, electromagnet housing, and the thin wall iron tube, structural insulation composite; in operation, the pipe/sleeve presses against insulation spool to press against ‘cold’ thin-wall tube, ‘cold’ flange, counter-flange, to ‘cold’ electromagnet enclosure, to the ‘cold’ steel liner; ‘cold’ meaning materials heat transfers with the pipe/sleeve hottest and the liner coldest;
again, instead of one electromagnetic coil, said housing may enclose numerous separate ironclad magnetic-disk enclosures making similar aforesaid enclosure form, with individual power supply for each coil disk with direct, IF surfaces, contact with the flange and counter-flange; coil disks-power operations should symmetrically energize the disks about the enclosure generally, thus in pairs or preferred groups of three, when a failure in one disk is overcome by the other operating disks or one group's failure overcome by the other operating groups; sequential or back-and-forth disk operations under pipe vibrations induced shear stress failures in the fluid magnetized mass structural member said operations reduced shear stresses dissipates vibrations energy; magnetized fluid when energized heals shear failures, which tunes vibrations response, magnetized fluid latent muted dynamic responses out of vibration frequencies resonance ranges;
the electromagnetic soft iron core, continuous single wound wire, coil disks axis parallel with the pipe spool centerline inside their ironclad annular enclosure for a separation from the enclosure allows for each individual disks' removal, repair and replacement inside said annex building without cutting the pipe spool; remote-control sensors as extensometers, with at least two-digital-channels, transmitted vibration displacements to data processing units allow for computed electromagnet(s) operation; the insulation/thin-wall tube spacings from the electromagnet(s) housing constitute said spool's largest lateral displacements;
the supra five major innovations, especially the fifth, make first step toward the first, second, and third most significant innovations; the first step constitutes supra four of the listed five expansion joints as the five nuclear power plants thermal expansions, vibrations, elbows, bends or kinks and fluids directional changes major innovations; the first most significant innovation allows for nuclear plant electrical power generation to highest efficiencies with much longer life spans, thus much lower power generation cost per kilowatt-hour, through subdivided present art containment building into three space entities with specifics in function; the first significant innovation constitutes the containment building reactor vessel cylindrical space with the diameter that allows maintenance, such as in refueling the vessel head removal, reinstalling of the reactor head; thus essentially unchanged space utilization, from the present art, enormously reduces the containment building diameter from about 140 feet to a diameter barely greater than the reactor vessel shield wall, from the containment foundation to elevations that must surpass the steam generator/separator highest point, with corresponding construction capital investments' savings; very much freed plant space results from its removal from the containment building with construction pressure vessel's structural parts whose stress analysis, thus follows:
□₁/r₁+□₂/r₂=p/t,
wherein r₁ is radius in this case that of cylinder height that is very large to infinite which removes the first term of the equation; the □₂ is hoop stress essentially entirely reduced by said annex building shear-walls extending radially in respect to the reactor vessel, from said cylindrical containment building part through the annex building, in turn transferring the hoop stress □₂ through said shear walls constituted primarily of various structural steel bracing, from said circumference into the reactor foundation; then, the cylindrical wall is designed for bending moments in spans between the shear-walls/structural bracing; then, pressures ‘p’ relate to thicknesses ‘t’ shear and bending stresses and not on the above equation applying specifically to pressure vessel membranes; subdividing the annex building into reasonable width bays, with aforesaid structural steel said bracing, radially converge into narrow bays, subdividing the cylindrical wall into very short circumferential spans very much smaller thicknesses, more economical sections than the present art; said containment building second of three parts, the upper half-dome part, is unchanged, from the present art, according to the above equation's terms, with its base constituting a floor slab supported by the annex building perimeter wall under the dome's shell and said bays' structural steel bracing or shear walls; said containment building subdivided from one into three ‘globose’ forms is obviously a preferred economical containment construction and is much more secure; a flying turbine disk or a flying missile must penetrate the dome, its floor slab, and said cylindrical wall thick sections; the turbine rotational plane disk released into near ground projectiles will have trajectories away from the containment building; a tornado created missile lower energy ground elevations paths have to pierce through the annex building bays, walls, floors and equipment, such as steam generators/separators, high pressure pumps, and at least the cylindrical wall in order to reach the reactor vessel's shield wall or its head; said dome, its polar crane precludes a missile almost entirely vertical reactor hitting trajectory; the subdivided containment building constitutes multiple sequential perimeter boundaries much safer design with globose forms composites protecting, the globose reactor centric location, for surviving a serious annex building damage with one cooling loop functioning; the containment liner penetrations reinforcement is analogous to naval vessel pneumatic door-sill designs; globose perimeter surface contains most space that mass energy prefers, least lengths, linear, radial, most interstitial spaces volume, and most natural paths, mass energy patterns that light and radiation exemplify; the annex has exactly said paths, spaces, over ten floors, the present art sorely missed maintenance space; the globose forms reduce and avoid bending stresses tension-compression and provide for said longevity; globose perimeter surface contains most space that mass energy prefers, least lengths, linear, radial, most interstitial spaces volume, and most natural paths, mass energy patterns that light and radiation exemplify; the annex has exactly said paths, spaces, over ten floors, the present art sorely missed maintenance space; the globose forms reduce and avoid bending stresses tension-compression and provide for said longevity;
the second most significant innovation locates steam generators/separators in the annex building, just outside the containment cylindrical wall, under the containment's dome, to enable their replacements; said floor slab includes access hatches, just above the steam generators/separators, in design analogous to the containment main access equipment hatch, said naval vessel door/sill designs; highest lifting capacity crane motor, block and tackle and outriggers in the containment through the equipment main access hatch the containment building polar crane places above a steam generator separator in preselected containment, and annex building's designed locations, for replacements purposes egress and ingress spaces, preselected length, width and elevations through the annex building with bays structural members temporary removed for adequate spaces and supports and cranes capacities; this includes annex building perimeter oversized doors and or removable structural frames and panels; the steam generator/separator is lifted for a flat bed trailer wheel to wheel, axle to axle closes spacing one section at a time assembly thus reassembled having steam generator/separator multiple cranes lowered onto the flat bed trailer cradles; adequate capacities of flat bed trailers and cranes replaced steam generator/separator constitutes said plant longevity second step, as the present art imprisons the steam generators/separators for the containment buildings' least longevity;
the third most significant innovation ameliorates the present art structures mass energy losses for the globose reactor, ‘globose’ steam generator/separator vessels significantly highest heat energy transfer, with supra containment/annex building configuration; clearly, high energy piping, conduits, least masses occur in straight, short (least length), least vibrations piping (least energy loss to structure) passes through sealed globose perimeter boundary (containment building) heat energy (fluid mass pressure, temperature) transfer among said globose vessels for fluid mass least directional change; said GC perimeter boundaries longevity mandates almost nearly free thermal expansions, dampened dynamic vibration responses for the mass energy preferred said paths and patterns perimeter boundaries' formations multiple serial enclosures light water reactors (herein) pressurized system conduit tuned piping mass energy processes and buildings complex, boundaries safely closed perimeters; said plant's mass energy least, shortest radial piping paths inherent peculiarities arising from the present art piping conduits flexing allowed thermal expansions built into major equipment mass energy conduits Inlet and outlet forms; said peculiarities not withstanding the steam generators/separators, the loop return legs high pressure pumps are the annex building located, very close to the containment liner and concrete wall on one side, with the reactor vessel on the other side; pipe spools shortest lengths, least vibrations, tuned containment penetrations and steam generators base-plates; steam generator/separator two return legs per loop constitute preferred symmetric configurations version;
current state of art, nuclear power plants major equipment is engineered, to an extent of ‘globose’ shape; however, major equipment and building configurations, incorporated as a whole, exemplifies crafts and trades construction; the Background depicted “forms equal function” methodology rationale without examined ‘cell substance’ specifics and scrutinized ‘cell’ with closest observation of perimeter boundaries leads to error margins on the order of two magnitudes, especially in fluids related mass energy; the ‘forms equal function’ rationale has uncertainties even when examining a crystalline structure from solidification of a chemical element, a compound, or a mixture that makes regularly repeated internal arrangement of its atoms and often external plane faces; on the other hand, regularly repeated paths with patterns make said GC Sets and forms repeated quantum mass energy internal arrangements with perimeter boundaries not as distinct, because externally GC Sets and forms do not readily disclose fluid masses' laminar flows; ‘forms equal function’ rationale entirely fails without the Laws that distinguish fluids laminar flows most orderly ‘substance’, quantum masses energy arrangements, least resistance paths, paths-of-passage of least energy demand, PPLD, that has the ‘function’, energy/power self-conservations; fluid mass energy ‘forms equal function’ alone always errs, proven unable to differentiate mass energy functions two orders of magnitude among crafts and trades, engineering disciplines, and Arts and Sciences Sets and forms, and not much less error margin distinctions with a combined ‘function’ of said three; thus, said current art of nuclear power plants, including patents allowances which do not discern ordinary from perfection, analogous to crystals, crystalline lattice from diamonds' light dispersions, and from bizarre applications and patents to diamonds perfection said ‘genomes’ QCMEHC; unique quantum mass constitutes ‘substance cells’ given locations precisely performed ‘function’: for diamonds light dispersions, for ‘genomes’ Earth's most unique, rarest, clearest ‘function’ more than diamonds rare mass energy patterns boundary MEHC transistors/processors; the ‘genomes’ make the Universe only such embodiments with ‘black holes’ as only possible exceptions;
mass energy paths and patterns internal, external arrangements with perfection and imperfections grow GC Sets and forms analogous, much like crystals do, with the whole structure conglomerate of alike elementary ‘cell’ units; said MEHC perimeters boundaries can overcome to an extent apparent crafts and trades construction deficiencies, ‘cell’ imperfections through applications claims GC Sets and forms mass energy paths shown patterns, inventions, principles and methodologies; electromagnetic fields and fluids utilizations as part of flexing perimeter boundaries continues from the applications Ser. No. 09/850,927, dated May 8, 2001; Ser. No. 09/518,884 dated Jan. 16, 2001; and Ser. No. 60/187,270 dated Jul. 11, 2000; supra electromagnetic seals complement said containment, annex building and the reactor vessel, steam generators appropriately configure perimeters, boundaries' formations, multiple and serial enclosures from said crafts and trades to engineering methodologies GC Sets and forms; pruned, compartmentalized reactor, containment, building content except for the reactor vessel only, has huge cost savings, initiates balanced, radial and tuned plant, for said annex added over ten equipment floors; supra ‘substance’ part, aside from ‘forms equal function’ has fluid mass energy perimeters boundaries freed thermal expansions avoids thermally induced static and dynamic bending moment stresses, except for the reactor, steam generator/separator inherent peculiarities;
high energy MEHC conduits least (fluid) mass, straight, short, least vibrations piping has primary cooling loops faster turnover rates, heat energy delivered to steam generators/separators with least friction losses, lower high pressure pump power required; thus, saved power allows for enlarged piping diameter further reduced frictional losses with larger fluid mass per turnover, entirely combustion engine analogous to much lower frictional loss higher revolutions per minute larger cylinder displacement produced energy; said prior application ‘genome’, two orders of magnitude mass energy savings, makes a very useful point;
steam generators/separators are weakest links in the primary cooling loops; thus four innovations; one, allowed thermal expansion, damped/dampened pipe vibrations ameliorates the steam generator tubes stress corrosion cracking related to vibrations; two, the annex building's greater interstitial, maintenance space allows quicker, easier access to locations; three, the steam generators/separators said replacements remove them from plants' longevity critical lists; four, in said annex, their horizontal designs is practical;
said compartmentalized reactor building, the annex as its extension, freed thermal GC expansions avoided conduit bends, significantly reduces the present state of art structural perimeters banding moment stresses, and moves nuclear power plants construction from crafts and trades to MEHC patterns; banding stresses removals from structural perimeter boundaries makes GC structures compatible with fluids which transmit shear stresses, only; avoided banding stresses indicate no mass energy directional change which enhances MEHC; thus, the current art in numerous instances and MEHC are entirely incompatible; said horizontal steam generator/separator peculiar GC form entirely reflects its reactor building confined space and related thermal expansion provisions; supra inventions provide for MEHC approaching a QCMEHC power plant embodiment eliminated all high energy piping elbows, especially with inclusion of the last of the listed five expansion joints; steam generators/separators in said containment extension annex permits preferred horizontal versions or their shape peculiarities along with the reactor vessel interactions, elbows shape and piping configurations deviations from globose forms strengthened with various stiffener plates;
then the sixth major innovation eliminates the steam and primary cooling loops' isolation valves, with the seventh eliminating substantial structural supports and restraints because of significant reductions in piping stresses in general or bending stresses in particular; again, due to GC perimeter boundaries freed thermal expansion configurations and said ameliorated inherent peculiarities; said reduction of stresses is proximate to one order of magnitude; mass energy paths and patterns are short, compact, and streamlined as GC perimeter boundaries are allowed to expand and contract once per refueling outage, currently about 18 months; and low stress members metal fatigue, in less than one thousand cycles, is not a valid concern; currently postulated double guillotine pipe break scenarios no longer constitute valid concerns, especially for primary cooling loops and especially with supra innovations lead to longevity innovations that follow; primary cooling loops' major equipment, the steam generators/separators, respective high pressure pumps and the reactor vessel GC perimeters' boundaries freed thermal expansion, with their respective structural supports, constitutes the sixth and the seventh major innovation significant part; steam generator/separator one or multiple legs base plates weld to a larger base plate, counter-plate assembly, with the counter-plate stainless steel base same or precise finite difference higher elevation in respect to the reactor vessel's steel supports base plates; each high pressure pump has the same, but much smaller, assembly, with the cooling loops piping centerlines remaining horizontal which said precise finite difference(s) provides; each of the assembly base counter-plates surface area is supported by said insulation, and is inside side insulation ring that elongates into an ellipse with the major, minor axis difference and axis orientation that have precisely the thermal expansion magnitudes and directions allowed; with the steam generators/separators, said axis difference orientation is radially outward from the reactor vessel upright centerline; under heavy pressures said axis make-up perimeter ellipse, enclosing vectors that vectorially sum each assembly radial and polar thermal expansions in respect to said reactor vessel centerline; the counter-plates surface area/perimeters each shape is smaller than said insulation ring which is backed by a stainless steel plate ring; said smaller counter plates permit thermal expansions, contractions, primarily along the respective base plate's surface area interface, with insignificant base plate/counter plate bearing reduction area surfaces; said base plates further include a rim-plate upwardly extended along each plate's perimeter to face said thermal expansion elongation gap to said insulation backed by the steel ring as said assembly backstop; the rim-plate height matched by the insulation and the backstop width is at least several inches for all locations, with thickness of each that provides for sufficient structural strength; at least four machined channel-guides oriented for the respective base plates thermal expansions/contraction axial direction, channel location and orientation; said channel guides counterparts machined pins among various pin shapes may constitute a threaded stud, each through a pin arm threaded-hole with its rounded point torqued pressed into said channel counterpart groove; welded to the backstop the aligned pin arm allows base plate said axial thermal expansion moves;
the base plate, counter-plate said IF coated surfaces readily allow thermal expansion movements; unless regulations required, the steam generator/separator huge weight makes channels/pins unnecessary;
the base plate covered by the turbine paste lubricants, with/without a heavier wax sealed surface, allow melted paste to flow, into and out of thermal expansion space through several holes through each of the rim-plates, lubricating the IF interface; the base-plates as with the containment building penetrations, the turbine pastes as IF base fluids allow electromagnetic disks said numerous arrangements with housing welded to said base plate or backstop, positively attached with full penetration welds of sufficient lengths;
said high hydraulic pressures structural, prestressed, electromagnetic, energy-pipe, the listed fifth among expansion joints constitute the forth most significant innovation; a high pressure steam line spool one end has about three wall thicknesses, greater outside diameter than expansion joints counterpart-spool outside diameter that is turbine direction oriented with typical spool wall thicknesses and outside diameter for the other end; said spool larger diameter, heavier wall, thicknesses end is machined to inside diameter slightly smaller than outside diameter of the counterpart-spool plus a welded reinforcing-sleeve thickness, matched, precisely machined diameters; the inside diameter accounts for required inorganic fullerenes, IF, coated entire surface; said inside diameter transition that matches the machined counter-spool's end has a smooth sharp angle beveled surface which butting into the welded reinforcing-sleeve closes the expansion joint outer portion with the sleeve's front surface, transition bevels matching surfaces; the expansion joint transition from the machined inside diameter to piping spools' inside diameter constitutes another slightly sharper angled bevel that matches exactly the counter-spool's machined end bevel, wherein said matching bevels abutted closes the expansion joint inner portion; said expansion joint's inner, outer portions closing simultaneously closes the expansion joint; said bevel that terminates into the pipe spools' inside diameter has a very fine, small, outside corner fillet which finitely, smoothly extends into the bevel for a fraction of wall thickness and a longer length along inside diameter surface with said fillet lengths creating suction in the expansion joint as it closes; about one magnitude less than the building codes allowed piping stresses, herein, inventions implemented close and open the expansion joint for anticipated millennium longevities;
each expansion-joint spool welds to another expansion spool from the counter-spool's end facing the containment with at least one preferably two welded two reinforcing-sleeves, which are prestressed by a preheated outer-spool slid over and allowed to cool over the reinforcing-sleeves; the reinforcing-sleeve outer, the outer-spool inner diameter surfaces are machined for a precise ‘negative’ tolerance wherein said surfaces have each inorganic fullerenes coating with the ‘negative’ tolerance caused prestress; the outer-spool, the expansion-joint spools have same lengths; the reinforcing-sleeves are spaced for the expansion-joint spools made first welds, with needed access; then, the outer-sleeve is force slid into a position for its weld; at least two preferably three outer-sleeves complete the expansion joint and the reinforcing-sleeves with pre-welded locations from each expansion-joint sleeve respective end having equal spacing; at least the outer-spool closest to the containment and preferably three reinforcing spacings enclosed volume shall have fluid inflow and outflow (drain) pressure portals positive shut-offs; a fluid, such as turbine lubricants molten paste, volume under pressure in said spaces monitored continually assures the expansion-joint seal integrity; supra electromagnets and turbine pastes electromagnetic fluid assemblies allow electric current and fluid pressure monitored seal integrity, supra and following depict magnetic coil location orientations;
said high energy line expansion joint eliminates the present art steam lines paths snaked along the containment building's perimeter from the top of each steam generator/separator, along containment sides through the containment floor-slab, into a steam lines tunnel under the containment and auxiliary building to rise to an elevation above the turbine and make elbows into the turbine casing; said inventions take out all of the present art complexities huge capital expenditures; said major equipment peculiarities are taken for consideration; most significantly, eliminated steam tunnel structure and piping in the containment and steam tunnel eliminates substantial structural supports and restraints that undermine plant's longevities by thermal expansions and pipe vibrations, such as water and/or air ‘hammers’, energy transfers from already generated energy into piping and buildings structures; such losses take directly ‘cream’ benefits out of the generated energy and sink it into structures' degradation, making their lifespan shorter than a millennium;
the fifth, most significant innovation, modifies the present art said reactor, annex, auxiliary, with spent fuel pool, decontamination and turbine equipment, buildings functions, and interstitial, maintenance spaces from crafts and trades to engineering disciplines designed construction, electromagnetic fields said fluids seal, globose-conduit, GC, balanced and tuned perimeter boundaries to allow millennium longevity; described conduit direct shortest conduit paths and globose major equipment and buildings globose forms perimeter boundaries simulate QCMEHC self preservation, self conservation preferred paths and patterns; further advancements toward nuclear power plants GC QCMEHC constitute further shortening of conduit lengths by judicial enlargement of conduit diameters and globose major equipment, especially by resolved equipment deviations from globose forms MEHC functions, which inherently corrects conduit deviations; advancements continued into Arts and Sciences QCMEHC complexities resolve infinitesimal deviations;
prior applications drain-traps Universe forms and Sets extensively exemplify major differences in crafts/trades and more advanced construction and engineering disciplines finite to infinitesimal deviations from Arts and Sciences Sets and forms; ‘substance’ must comply with the Laws of Mass and Energy and the First Law of Thermodynamics function mass energy preferred paths and patterns which superimposed over a tested ‘forms equals function’ Sets and forms must coincide with those of QCMEHC; the scientific communities failures to include atmosphere's fluids changing perimeters boundaries introduce fatal errors which the application GC Boundaries describes with extensive perimeter boundaries undeniable evidence,
masses energy inventions, principles and methodologies must comply with said Laws ‘substance’ function and paths and patterns; otherwise any related subject matter aspect at best is in the realm of crafts and trades construction; ‘best operation’ applies vaguely but lacks common facts specifics persuasiveness;
thus, separated reactor vessel and steam generators/separators closest proximity while in separate buildings allows for maintenance replacement and longevity of one without impacting these of the others; for the same reasons imposing said equipment ‘functions’ into one are proven technologies century away; clearly, said shrunk lower containment building part presents a flying projectile smaller, strengthen and a better fortified target with the annex's floors, bays and equipment; entire half of the annex building fully destroyed would not preclude the reactor's safe shutdown provided said building compartmentalized other half, analogous to naval vessels' pressurized compartments, is supplied in emergencies with cooling water to the reactor vessel head, below steam generator/separator high pressure pump exposed motors elevation;
buildings separated/compartmentalized equipment ‘functions’ interconnect with said shortest and straightest conduits without limitation to their diameters, thus, primed for MEHC said conduit, equipment said inherent peculiarities' extent into conduits debugged analogous to mass energy ‘genome’ similarities; thus, each fluid's retained, detained, transposed, transferred, or transported mass energy functions fastest turnovers is balanced, tuned, ‘genome’ methodologies/principles adopted, combustion engines analogous, inline two or radial four, herein, steam generators/separators; mass energy inherent self preservation, self conservation readily conforms to any perimeter superimposed functions utilized energy, spent longevities, with a boundary mass energy dissipation eventually contributing to said gradation stratification processes; fluids sealed perimeter boundaries, especially electromagnets electromagnetic fluids, thermal expansions, contractions free movements, allowed to repeat, during re-fuelling outages and lowest, especially bending moment, perimeter boundary stresses by said innovations constitute least energy, unavoidable dissipation;
heating, ventilation, and air conditioning, HVAC, fluid, gases/air ‘substance’ mass energy, that is Laws of Mass and Energy Conservation with Thermodynamics MEHC linear paths conduits' transported, Globose Sets, forms retained, detained mass or transposed energy dissipated patterns unless superimposed ‘forms equal function’ enforces identical perimeter boundaries; in fact perfections do not exist, except for said ‘genomes’, which prove as rare as they are they are achievable in elementary ‘functions’ and ‘forms’; forced ‘forms equal function’, Sets and forms superimposed over mass energy said GC paths and patterns must yield common perimeters boundaries or MEHC dissipates; said shortest most straight conduits and containment penetrations correctly separate major equipment said functions, maintenance, or replacement with appropriate interstitial, maintenance, spaces; thus, the reactor, annex, and turbine building buildings shortest most straight paths said inline two or radial four alignments is absolutely correct and points to the debilitating, upright steam generators/separators bug within the pressurized reactor present state of the art; the annex building readily provides space for horizontal steam generators/separators technologies that are available, with years of fossil fuel plants experience, as well; horizontal steam generators/separators allow significant cost with the reactor building said lower part, the annex building height shrunk nearly to a half of the present art building height, where said construction cut costs cut design, licensing, and construction periods time costs; this in turn, cuts along with cuts in valves, structural supports and restrains, electrical cable and equipment maintenance, interstitial, space, buildings, cuts HVAC gas/air fluids equipment costs construction and management; radiation, excess pressure, in the reactor building, HVAC processes scrub or filter with clean air discharged; with a reactor building pressure overload, the annex building becomes a temporary reservoir; sealed annex building required access for maintenance should occur less frequently than required in the containment, with said buildings spaces also available with exception of control room and habitable space in the auxiliary building; the annex building's pressure increase has the containment wall said lower part in tri-axial compression, adding to safety and sealing of that containment part; power plant's steam generation produces by electrolysis hydrogen and oxygen that easily temporarily store in the auxiliary or annex building; the HVAC should not, under any circumstance, allow these gases to escape; an insulation cylinder placed around the reactor shield wall avoids direct radiation heat into the steel liner;
said four innovations to the present art steam generators/separators lead to the fifth; at the top of the steam generator/separator, a shell perimeter globose form replaces the steam line U-bend and encloses the steam generator separator uppermost part, to separate into a steam line extended downwardly to a trust block transmitted horizontal and vertical loads and shear stresses into the reactor, annex building common foundation; steam generator/separator structural backstop enclosures transmit loads and stresses into said foundation consistent with the present art; a required structural lateral support from the containment wall to the steam generator/separator support attachment on opposite side with the support arms length thermal expansion equal to that of cooling loops outgoing legs; said attachment at highest suitable floor elevation keeps a steam generators/separators position stay upright, necessitating removable horizontal brace across the reactor building refueling channel; removed during refueling the brace with the reactor vessel head is stored temporarily on the reactor building said upper floor slab; transmitted dynamic loads through floor slabs avoid banding stresses; said horizontal generators/separators usage removes 180, 90 degree elbows;
supra, least length high energy conduit lines' innovations lead to the eighth major innovation said high energy conduits' triaxial compressions achieved by said outer-spools, reinforcing-sleeves weldments that likewise simpler construct by the successive reinforcing-sleeves, outer spools welds, inline assembly; the reinforcing-sleeves or outer-spools either one or both can constitute welded halves; spools and outer-spools constituted space pressurized with argon or other gases including air, or an electromagnetic turbine lubricating paste, or such similar fluids transfers in part spools hoop, vibration, peak, and bending stresses to the outer-spool which becomes sacrificial material repairable without causing an outage; each separate space outer-spool has separate respective fluid inflow on top, drain on bottom threaded and capped portal;
said ironclad annular enclosure multiple disks electromagnet heads, herein, face said annular ring inner radius and constitute mechanical, victalic coupling, herein, four bolts devices assemble in-place two halves around the outer-sleeves and their said structural insulation; said electromagnets, victalic coupling devices rolled on carts with wheels locking device into a selected position electromagnetic force lock unto the outer-spool, said insulation and spool as adjustable supports vibration damping devices for the piping; sufficient electrical power, which magnetizes heads' coils, can make said spool, magnetic fluid, and outer spool a solid structural/mechanical spool member, transferred largest bending stresses to outermost fibers;
the ninth major innovation minimizes power plant structures and equipment energy of distortions that shorten plants longevities to maximize electrical power generation efficiency; in fact, this innovation summarizes supra innovations and known in the art theory of elasticity energy of distortion derived values that result from various stresses accompanied strains with strains in boundaries perimeter, GC boundaries perimeter hoop stresses minimize bending stresses and allowed thermal expansions least strains conserves fluids mass energy, reduces stresses/strains, for least distortion energy plant increased longevities; a least length path, straightest from the reactor vessel to the turbine/generator minimizes distortions energy taken out of fluid masses energy that otherwise generates electrical power; said conduit innovations, said steam tunnel elimination, and said major equipment, herein, disclosed or inferred, major energy savings result in this innovation; the ‘disclosed, inferred’ includes the buildings revisions, equipment relocations, reduced stresses and loads transmitted through floor slabs to foundation with least or no banding moment stresses;
optimal mass energy paths and patterns electrical generation least energy of distortion constitutes the turbine building, reactor buildings common floor slab buildings and equipment the inline two or radial four configurations balanced tension/compression axially transmitted forces; said balanced configurations two or four tuned cooling loops' steam generator/separator branches include turbine buildings, condensers vibrations tuned column legs, foundations said axial stresses reduced, thus least banding moment stresses; shortest path steam lines from the steam generator/separator to the turbine makes preferred elevation least difference from that of the cooling loops with wall penetrations as described for the containment building;
said configurations allow for potential removals of the turbine peculiarity requiring an elbow into turbine casing from a steam line at a higher elevation; said electromagnet fluids tuned anchor base plates, expansion joints least pipe stresses, and floor slabs removed banding stresses should eliminate the elbows;
least lengths, allowed thermal expansion, least stresses especially banding, and spool/outer-spool double wall piping eliminates need for isolation valves as pipe break in this construction, not a double but a quadruple guillotine pipe break is not a viable concern; said liquids or electromagnetic fluids transferred said stresses make outer-spools uninterrupted operations repairable, sacrificial conduits, whose integrity is verified with remote control pressure sensors in said portal caps, which precludes a potential piping break; except for equipment inflow, draining isolation outflows, and safety valves, said piping eliminates valves; inherently unfailing gravity force underground aqueducts water flooded said annex building high pressure pump bay, compartment, and loop in a theoretical pipe break following site and aqueduct details describe;
substance, matter, mass and energy, mass ‘function’ contains, retains its mass in globose ‘forms’; energy itself has transport ‘function’, fluids flow analogous energy instances constituted conduits ‘forms’; the sixth and seventh most significant nuclear power plants' innovations are site locations and elevations selection based on preferred water masses energy heat transfers from atmospheric precipitations, together with electrical power generation heat energy byproduct, into the Earth's crust locations; the present state art plants site selections seismic evaluations trend toward preferred seismic inactive locations; also, here, said state of the art seismic evaluations and inactive preferred nuclear power plants locations apply to site least active seismic zones tectonic plates' centric portions, again away from major faults; power plants at these locations transfer heat energy into the Earth's crust cooler masses, thus, away from fluids' hot spots, magma masses generally coming to the surface along plates' perimeters; the heat energy as power plants byproduct waste, in fact is used to cause tectonic plates thermal expansions toward said fault line closings eventual tectonic plates' expansions, closed hot spots reduced volcanic activities, the Earth's crusts sealed tectonic plates masses and perimeters, and cooler atmosphere; prior application, QCMEHC underground aqueducts strategically locate paths from proximities of their water sheds to seas or oceans; said strategic paths most centric, sufficiently underground cooled aqueducts' water masses, tectonic plates' most centric locations represent preferred nuclear power plant sites; thus, the site globose ‘form’ contain, retain mass ‘function’ strategic fluids, water aqueducts, magma masses heat energy linear, radial heat energy transfers respective transport ‘functions’ intersection; site selected nuclear power plant is globose-conduits serial or successive, formations perimeters boundaries, engineering disciplines highest conserved mass energy Sets and forms energy patterns strategic paths location inside an advanced mass energy processor that is Earth;
said selected nuclear power plant complex reactor vessel head sets a natural water level elevation based on incoming aqueducts water level elevation flooding said annex building compartments and a bay; said elevation gravitational force MEHC pushes once-through turbines' condensers cooling water system;
the tenth major innovation encircles nuclear plant's complex into a globose perimeters boundary, bentonite slurry wall extending from bedrock, significant depth, or an impermeable soil layer to a berm or a levee crest absolutely precluding flooding into site perimeter; inside the perimeter the groundwater level is held below the reactor building foundation, with a network of perforated field tiles sand filters and filter fabric encased draining into a reservoir where two pumps each with a capacity to preclude a ground water rising; reservoir groundwater is tested and if needed scrubbed prior discharges through aqueduct network;
the slurry wall is also expansion joint filtering out plant site most damaging seismic longitudinal, compression waves by allowing energy dissipation with displacements inside bentonite slurry thick walls; this seals groundwater, with even groundwater inflows into said site perimeter a remote possibility, only; site locations distant from quake epicenters greatest concern are seismic longitudinal compression waves; slurry walls, berm least thickness for a required depth construction alongside aqueducts sufficiently away not to degrade compacted subgrade into and from the turbine buildings positively seal said site from water inflow; the aqueducts slurry walls as two more seismic compression waves isolation, fluids inflows sealed joints that positively isolate and avoid underground uncontrolled mass or energy inflow into the plant site;
the reactor, annex buildings eleventh and twelfth major innovations constitute a cup and a saucer foundation with the buildings as the cup; the saucer constitutes a thick reinforced concrete slab anchored in bedrock or bedrock anchored caissons supported said slab; closely spaced radial ribs in the slab's upper surface extend radially from the slab center into a foundation perimeter wall facing saucer's rim wall with buttresses; said outer saucer wall face has buttresses radial directions aligned with said horizontal ribs on said walls, as buttresses that anchor into bedrock or in the caisson foundation into compacted backfill and the saucer slab; a Teflon sheet sandwiched between two stainless steel plates on top of the slab horizontal ribs upper surface has sufficient depth, between said ribs, to said plates height of medium and fine grained angular sand compacted in excess of 95% relative density; cardboard encased dry bentonite sheets cover the sand backfill between Teflon sheets and covered with polyvinyl plastic sheets that preclude a moisture penetration into the backfill during construction, especially during concrete pours; said reactor and annex building floor slab and foundation wall are poured against the saucer perimeter wall that is lined with said bentonite sheets, thick Styrofoam, and said polyvinyl sheets which precludes again a moisture penetration to the bentonite; said construction further includes rectangular ducts, vertical shoots, between said saucer and buildings foundation walls entirely radially buttresses aligned, for said saucer foundation entire height to grade elevation; stranded stainless steel wires' lengths continuously spacing elastomeric-pads, lowered the shoots, to the foundation slabs and said annex building floor slab elevations; space voids between the saucer and cup foundation walls and in-between the shoots are filled with fine clean sand; soft compacted clay fill of at least several feet, sloped for surficial water to drain away, protects said spaces' construction;
the nuclear power plants thirteenth, fourteenth, and entire technology major innovation constitute a stainless steel water ‘tower’, globose-dish truncated at grade level for its functionality; said globose-dish has required water holding capacity and stainless steel liner integrity structural, maximum allowed cutouts reinforcement stiffener ribs, grade beams, and diaphragms that permit water flowing through but preclude splashing, especially in a seismic event; highly streamlined ribs, grade beams, and diaphragms for laminar flows constitute said globose-dish QCMEHC; the subgrade soil adequacy, soil borings verified, removes any unsuitable material; a compact backfill as a part of structural foundation must exceed 95% probability of exceeding 95% of relative density and consist of clean, well graded coarse gravel; coarse, medium, and fine sand; stainless steel liner over the grade beams and diaphragms encloses the dish and allows backfill and heavy equipment traffic over the dish; the entire construction including the compacted backfill must constitute 115-120 lbs/ft³ density well compacted-soil ‘floating foundation’ with entire structure including backfill, equivalent to the weight of soil removed; water into said dish comes from closest aqueduct, in a gravity flow, through a pipeline at grade; one or more underground pipelines through a short length, width and height tunnel from the dish into said annex building bays compartmentalized enclosures supply flood-water volumes needed; cork or rubber flexible backing material seals pipe penetrations through said cup, saucer annex building wall, with mastic and supra cocking sealers; instead of said backfill with vehicular traffic loads over the dish, cooling towers supported by said stainless steel construction, grade beams with diaphragms, as a replacement, is an option that provides equipment cooling water by gravity and also cool said compartments or bays; in that option a return pipeline into the globose dish at grade must include the annex building pump, said walls' sealed penetrations and water dish capacities that allow for evaporation;
said aqueduct is cooling water inflow into the plant site that allows for said pipeline at grade that fills the globose dish by gravity; the globose dish may constitute a protective liner interface between said backfill and stainless steel; among available liners is fiberglass sheeting location spliced, a concrete liner poured on site; the return pipeline utilizes said tunnel; said penetrations flexible sealers, including those of the present art, must preclude a potential for a double guillotine pipe break requiring appropriate repair, replacements inspections program addressing unusual, unexpected events not limited to earthquakes only; said water supply below frost line, insulated conduits with high velocity flows otherwise entirely drained, and operational highly heated water from major equipment cool-down preclude the water supply freezing;
nuclear power plants advanced designs constitute said GC QCMEHC least lengths, straight paths conduits, reactor vessels, horizontal steam generators/separators, and turbines/generators, present states of pressurized or boiling water reactor further revised technologies; the advanced technologies constitute the high-pressure steam nozzle in a short conduit length from said steam separator to the turbine, thus causing back-pressure increase into steam separator sole function; the boiling water reactor technology steam path is directly from the reactor vessels without generators/separators to turbines, which requires sealed turbine building radiation control; the nozzles' created back pressure in boiling water technology configurations extend through steam separator sole function raises reactor vessel's water boiling point temperature that is a basic pressurized configuration concept made possible by supra innovations, especially by the described expansion joints; further superheating steam by compartmentalized electric heating filaments immediately prior and passed the nozzles again raises back-pressure and water boiling point temperature; said primary loops eliminated pressuriser has construction cost savings; said electric heating elements provide for pre-heating the expansion joints to their closed positions and highly accurate steam pressure, temperature, and moisture contents quality delivered to turbines; said innovations call for reviews that should eliminate the elbows presently required for steam inflows into turbines making supra innovations even more beneficial; high-energy steam lines energy is from the common source, the reactor vessel, and thus should constitute equally split directionally balanced energy transport; the heating filaments raised steam temperature at the nozzles' allows for back pressure controls through entire system, constituting highly balanced tuned plant;
reactor building containment penetrations, with said steam generators/separators separated out of the reactor building into the annex building as the major most significant innovation, have another option; said structural insulation, with uniform widths narrow gaps ferrous-plates lined cylindrical circumference electromagnetic spools have wound wire over the plates, coil-length through which electric current passes magnetizing the plates whose ends turn outwardly into bracketed-plates that in installed position butt into a contact with the ferrous flange; the ferrous outward-bracketed plates, as structural members individually welded to a stainless-steel tube inside diameter transfers electromagnetic forces resisting the pipe motions to the tube whose length approximates the reactor building composite thickness with steel sleeve through, in the reactor building's wall; same lengths, narrow, symmetrically spaced structural boxes subdivide said tube perimeter; the boxes with three sides have adjacent pairs welded edges and welded to said tube make boxes which constitute only three sides, which with the tube slide into the containment penetration sleeve; the forth side, allows an elastomeric rubber/stainless-steel pads having matching sides dimensions tightly fitted between the sleeve and the tube, with the stainless-steel plates placed top and bottom with the plates abutting the tube, sleeve matched respective radii for elastomeric pad plate materials uniform thicknesses;
universally exhibited mass energy formations paths, patterns and forms are the Laws of Mass and Conservation ‘function’ phases of ‘forms equal function’, Universal evidence constituted energy preferred linear path conduit and mass globose forms; the ‘forms’ part and the ‘function’ phase to ever larger mass devise and merge globose-conduit forms Universe by ‘superposition property’-‘superposition principle’; the GC, globose-conduits, simultaneously exist with the Laws of Mass and Energy ‘substance’ or matter’;
accordingly, said plant site controlling mass energy inflows, outflows largest perimeter boundary is a bentonite slurry-trench, encircling wall, with fluids-energy, air masses, aqueducts water, precipitation, groundwater, seismic, heat energy subsoil interactions, electrical power, and fuel/waste inflows, outflows; only correctly sited, millennium lifespan of nuclear power plants can preserve this planet's living species;
equipment inflows/outflows ‘forms’, ‘function’ series configures from the reactor vessel and said steam generators/separators, to the turbine generator multiple primary coolant and steam loops and in said series succession the containment, annex, auxiliary, and ancillary buildings perimeter boundaries; two or four mass energy loops originate from the reactor vessel by superposition; multiple and serial enclosures perimeter boundaries' formations, constitute the light water reactors pressurized system GC conduit tuned piping mass energy processes and buildings complex, boundaries safely closed perimeters; said mass and energy processes ‘forms equal function’ constitute crafts and trades processes configuration of the present art to engineering sciences converted balanced and tuned to closest possible MEHC configuration conduit piping freed, to greatest extent, from major equipment crafts and trades construction process peculiarities;
accordingly, the Earth's processes degraded energy brief synopsis discloses the following points:
there is no ‘renewable energy’ as such energy has ‘dead end’ that will track oil and gas shortages history;
geothermal energy cools the Earth's mass magma, fluid, that generates the Earth's electromagnetic field;
wind power energy slows atmospheric circulation, Earth's rotation wherein either cuts Earth's longevity;
solar energy lacks energy grids, damages magnetic field and is 50-100 years into Earth's ‘tipping’ point;
nuclear power has chance to preserve or substantially increase Earth's longevity but costs are enormous;
the Earth is an advanced mass energy processor; enormous energy is needed to reverse, at least, in part damages done, with the atmosphere accumulated enormous water vapor, ‘greenhouse gases’ mass;
the Earth's eroded river beds have drastically lowered continental ground water levels, which in part was masked by melting of polar caps; however, both processes took cooling fluid from the Earth's surface and supplied the tropical belt's water for more rapid evaporation; said Earth's more rapid water evaporation to cool itself will fail because of enormous water vapor accumulated in the atmosphere whose mass is forced into radiation, irradiation heat energy retained which continually forces more evaporation; said processes cannot themselves rebalance the Earth's, the atmosphere's water fluids imbalance unless the atmosphere's suffers a partial blow-off; in fact, partial blow-offs are regularly occurring but thus far are insignificant in magnitudes and, if fact, are the Earth's energy processes most valiant efforts to preserve living organisms;
we should phase out all major energy generations accept for judicial utilizations of nuclear power that requires underground water GC aqueducts heat transfer into the Earths crust in best effort to preclude the Earth's magnetic field further deterioration while using most efficient energy generation technologies;
said nuclear power plants convert crafts or trades to GC MEHC processes, technologies electrical power generation-one strategic locations integrated plants site inside the Earth's mass energy forms, paths and patterns constitute inside the Earth's, the atmosphere's advanced processor natural energy processing;
said processing minimizes unavoidable, inherent perimeter boundary stresses and fundamentally avoids or minimizes banding stresses, vibration magnitudes, tunes piping conduits, structural supports, and building penetrations for no resonant frequencies response; the reactor vessel superimposed balanced inline two or radial four alignment is equipment generated energy processes, buildings complex of centric construction;
the GC MEHC arts and sciences nuclear power plants innovations, principles and methodologies disclosed processes and devices constitute ‘shovel ready-green technologies’ that require minimal reviews by overseeing agencies; capital investments per turbine/generator complex are most likely one half of the present art costs with simplified reactor building lower height with horizontal steam generators/separators enormously shrunk lower part and eliminated steam tunnel and double-wall piping eliminated high energy piping/steam lines isolation valves; on the other hand, per site's electrical generation doubles, quadruples for respective two, four energy loop configurations, with loops' conduit piping shortest lengths, especially from the reactor vessel to steam generators/separators that allow greater pipe diameters; these equipment peculiarities corrections allow for greater mass cycle turnovers toward reactor vessel, GC QCMEHC, fuel and control rods reconfigurations greater heat energy processing or greater generation of electrical energy,
with interstitial, maintenances, space improvements through elimination of said steam tunnel and extensive supports that were required to control piping heat and energy displacements extends longevities of structures and systems and provides for their time maintenance, also; with said minimized unavoidable, inherent stresses plant's life millennium expectancies are reasonable along with major equipment planned and expected rehabilitation and replacements that include steam generators/separators and reactor vessels;
the globose-conduit, GC, herein innovations, principles, and methodologies are expected to drive that project's longevity electrical power generation cost per kilowatt-hour by the two orders of magnitude;
the fifteenth major innovation constitutes said strategic locations integrated plants site, advanced processor natural energy processing, least stresses, most stable double-wall piping conduit and slurry wall most stable triaxial compression perimeter boundaries millennium longevity, which essentially solves the spent fuel disposal/repository ; first, because a developed site becomes and will continue as most valuable energy generations' assets that continue to develop through innovating replacement technologies, beyond said millennium longevity; second, the site is entirely secured against fluids leakage constituting an ideal reprocessing of nuclear waste location; third, with the nuclear waste reprocessing improved technologies making reprocessing profitable, minimal radiation waste shipment from the site to a repository will occur;
mass and energy has ‘forms’, ‘function’, and ‘substance’; present innovations' licensing of utility patents ‘forms’ constitutes globose formations of the atomic chart elements; the ‘function’ is undefined or infinite, because the Laws of Mass and Energy Conservation are excluded; the ‘substance’ part constitutes ‘forms’ and ‘function’; ‘substance’ or matter forms in instances of photographic snap shots, static images are those of said atomic chart table as most elementary; in time and space ‘substance’ constitutes dynamic globose conduit, GC, globose-conduit forms; ‘substance’ includes magnitude orders difference in errors; the GC enormously powerful when included within innovations, principles and methodologies are rooted in common origin with the ‘substance’ omnipresent said Laws ‘function’ Universal forms, paths, patterns;
mass-energy equivalence concept mandates existence of globose and conduit equivalence as each must have originated from a same ‘substance’ whole at a same time begs the question what the whole and the time are, and what was before that, Bose-Einstein condensate yields elementary histories, as it is not a solid or liquid; the globose atomic elements near the absolute zero temperature change into string forms, with curled ends; a laser light-velocity slows as it travels through said supercooled condensate's mass or ‘substance’ static very unstable images of elementary atomic forms; they too must have said same origin and said Laws ‘function’; there is only one unification concept for all of the above; at said temperatures the atoms unfurl themselves from a globose mass toward a conduit mass form in incomplete processes, as said unfurled atoms mass still makes curled ends; in the incomplete processes, globose mass change from almost entirely unfurled to conduit energy linear forms must have controlled condensate's further cooling, which is most likely a virtual impossibility and may require cooling below absolute zero, an impossibility, however, at entirely unfurled condensate ends, the atoms as conduit linear energy forms minimize further interstitial spaces which would further slow down any form of energy passing through; at the point when mass changes to energy, fusion of condensate mass-energy makes it a whole, which blocks passage of any energy including light; ‘substance’, ‘forms’ and ‘function’ Universe ‘black hole’ and ‘big bang’ originate; thus, ‘black hole’ and ‘big bang’ Universe is generic, genetically imprinted mass and energy relationship; ‘substance’ GC ‘forms’ enormous significance is on par with the Laws of Mass and Energy Conservation;
the globose-conduit enormous importance in predicting ‘substance’ unfurled ‘functions’ suggests the scientific smallest ‘God's particle’ pursuit is unbridled irrational exuberance; unfurling of mass into a conduit energy form discloses infinitesimal mass unit transformation into smallest energy unit which seek to merge with closest much larger mass-energy form leaving behind a void or a vacuum; in these contexts electrons are remnants mass portions shrunk from much larger mass portion with infinitesimal mass and a respective energy electric charge of a much larger particle; in mass-energy breakups, a very large portion converted to energy conduit forms after a continuous no interstitial-space mass ‘big bang’ breakup caused Universe of atomic mass and energy conglomerates; with our understandings of a uniform homogeneous solid, a breakup in a globose mass occurs with said solid material imperfections with stress concentration; a ‘black hole’ enormous triaxial compression maintains the globose shape unless severe bending stresses occur that cause distortions; a failure or a breakup has presence of both, stress concentrations and material impurities or imperfections; in a ‘black hole’ big bang, such failures phenomenon are natural, accidental or intentional; searching for smallest particle mass, unit of energy, while important must yield priority to—should the Laws of Mass and Energy Conservation hold up in ‘black holes’, mass-energy ‘substance’ will continue merging processes ‘function’; merging and breaking cycles will continue until repeated stressing and material merging removes imperfections with said gradations, stratifications as preliminary processes,
GC ‘forms’, the Laws of Mass and Energy Conservation, or ‘substance’ ‘forms’ and ‘function’, in a short or a long term, with a continual demand for more energy, all geological history, environmental and space data, evidence show that on a global planet preservation level on and universal level combat against said gradations, stratifications processes demands nuclear power processes response; said generation-one nuclear power plant processes transfer crafts and trades into engineering technologies or MEHC first steps toward ‘substance’ QCMEHC ‘forms’ ‘function’ superimposed by nuclear power generation ‘forms’ with ‘functions’ to infinitesimal perimeter boundaries differences; said MEHC or QCMEHC implementations make the breeder reactor more viable technology with said conduit innovations, site, major equipment and building configurations mass energy processes; of particular importance is said unfurling of atoms which makes initial fusion step toward its cleanest energy generation processes; the GC innovations, principles, and methodologies electrical power generation processes starting with environmentally most friendly said generation-one power plant configuration is critical first step, leading toward such plant versions to come; applying Moore's Law, here, has same investments in successive equal time intervals doubling electrical power kilowatt-hours generation, with plants new versions time intervals greater than those of processors; accordingly, ‘global warming’, ‘national energy independence’, and conservation of most valuable natural asset or lack thereof, water, are three prongs of stratifications, gradations processes constant, steady attack on this planet's survival; generation-one plant, nuclear energy, processes least contribute to stratifications, gradations processes, promise ‘global’ and ‘national energy independence’, combat ‘global warming’, and underground aqueducts heat transfer into the Earth's, fluids mass energy processes least mass transfer into atmosphere and cosmos; the generation-one plant heating crust processes retain Earth fluids, mass energy, environment, magnetic field strength, and life longevity on planet, which otherwise are gravely imperiled;
supra nuclear power plant crafts and trades Sets, forms conversion to engineering disciplines said GC MEHC primary loop coolant fluids constitute water or steam lines mass energy most positive entirely stable perimeter boundaries; the coolant fluids, water, site groundwater, underground aqueducts and water gravitational force supplied into the site and primary and steam line piping loops constitute said crafts and trades conversions to engineering disciplines GC MEHC Set forms; the underground aqueducts, globose-dish, and conduits gravity force laminar flows entirely at atmospheric pressure in their uppermost portions constitute most preferred QCMEHC forms;
